(19) United States
(12) Patent Application Publication
(10) Pub. No.: US 2018/0036882 A1
(43) Pub. Date: Feb. 8, 2018

(54) LAYOUT SETTING METHOD AND LAYOUT SETTING APPARATUS

(71) Applicant: CANON KABUSHIKI KAISHA, Tokyo (JP)

(72) Inventor: Gen Kimura, Kawasaki-shi (JP)

(21) Appl. No.: 15/657,684

(22) Filed: Jul. 24, 2017

(30) Foreign Application Priority Data
Aug. 4, 2016 (JP) 2016-153890

(51) Int. Cl. B25J 9/16

(52) U.S. Cl. CPC B25J 9/1664; B25J 9/1671; G05B 2219/40317; G05B 2219/40515

(57) ABSTRACT

It becomes possible to optimize setting of a layout of a robot and a peripheral device efficiently and at high speed in a robot workspace. A teaching point acquiring unit acquires a teaching point which corresponds to a specific operation that a robot arm accesses the peripheral device, and through which it allows a reference region of the robot arm to pass. An initial layout generating unit generates an initial layout of the robot arm and the peripheral device. A trajectory generating unit generates a trajectory of the robot arm based on the teaching point. Layout evaluating and layout moving units generate a new layout by changing an arrangement of each device based on the initial layout using a meta-heuristic calculation, set an evaluation value concerning fitness for the specific operation in the initial layout or the new layout, and set the layout based on the set evaluation value.

### BACKGROUND OF THE INVENTION

### Field of the Invention

The present invention relates to a layout setting method and a layout setting apparatus which set a layout for arranging, in a robot workspace including a robot arm and a peripheral device, the robot arm and the peripheral device. Also, the present invention relates to a method of manufacturing parts by the robot arm arranged using the layout setting method and a robot system having the robot arm arranged using the layout setting method.

### Description of the Related Art

In recent years, in production lines of automobiles and electromechanical (electric) products, working such as welding, assembly and the like is automated by introducing a plurality of industrial robot arms. In such a working environment with robots, robot equipment which comprises at least a robot arm and a peripheral device is arranged. Here, as the peripheral device excluding the robot arm, for example, a work (workpiece), a work piece rest, a jig and the like can be considered. Besides, in the working environment like this, there is a case where obstacles such as unevenness, a strut and a ventilation duct in a room, and the like exist. Accordingly, in the robot working environment like this, it is necessary to efficiently operate the robot arm while avoiding interference with the above obstacles and the peripheral device different from the working target.

Here, a layout (arrangement design) of the robot arm and the peripheral device has a great influence to attain such an object as above of efficiently operating the robot arm while avoiding the above interference.

In the past, determination of the layout of the robot arm and the peripheral device, that is, the arrangement positions thereof in the working environment, was sometimes performed manually on a paper such as a layout plan view in which the obstacle in the room was taken into consideration.

However, at the present time, since a simulator device such as a robot arm simulator is known, it is conceivable to support layout working of a process designer (manager) by performing layout optimization using the simulator device like this.

With use of a simulation technique, this kind of simulator device is used for programming (teaching) an operation (motion) of the robot arm by using 3D (three-dimensional) CAD (computer-aided design) data of the robot arm, a work piece and the like. To optimize the layout using this kind of simulator device, 3D CAD data of a peripheral device, 3D CAD data of an obstacle in the room, and the like are added in addition to the 3D CAD data of the robot arm and the work piece, and the robot arm is operated in such a virtual environment.

For example, when an operation (motion) simulation of the robot arm is performed by using the robot arm simulator offline, three-dimensional models of the robot arm, a work piece rest, and peripheral devices such as a jig and the like are arranged on a screen which is set by assuming the working environment.

Of course, a simulation result greatly varies depending on where the robot arm and the peripheral device are arranged on the screen corresponding to the working environment. If the robot arm is inappropriately arranged, there is a possibility that a part of a teaching point or a part of an operation (motion) path of the robot arm enters an area where the operation of the robot arm is impossible. In addition, if the robot arm is caused to perform an operation (motion) to follow the desired teaching points or the desired operation path, there is also a possibility that an interference with the peripheral device occurs.

Basically, in the conventional simulator device for mainly programming (teaching) the operation of the robot arm, a function for evaluating and verifying the layout is not implemented. For this reason, conventionally, even in the case of using the simulator device, most of layout evaluation and layout verification have been performed by an operator.

For example, on the screen, an operator has conventionally pursued, through a trial and error process, the arrangement of the robot arm and the peripheral device, which satisfies the condition that the robot arm is operable with respect to all the teaching points and the entire operation path and the peripheral device and the robot arm do not interfere with each other. However, even if the robot system is constructed by setting the arrangement of the robot arm and the peripheral device, it is not uncommon for a problem that a cycle time of the robot arm does not become equal to or lower than a defined value because the set arrangement is not optimum. In such a case, it is necessary to reconsider the arrangement of the robot arm and the peripheral device and again set it.

Particularly, in an environment where a kind of product is frequently changed, the process designer has to entirely redo the arrangement working every time the kind of product is changed. For this reason, the ratio of the step of performing the arrangement working is increased as compared with the step of actually activating the robot arm to perform production, so that productivity extremely decreases. Also, since the proportion that the process designer is directly involved in the arrangement working is high, a problem that personnel costs soar occurs.

Conventionally, an apparatus for determining the optimum arrangement of working targets by which a movement time of a robot arm can be shortened has been developed (e.g., Japanese Patent Application Laid-Open No. 2005-22062, and Japanese Patent Application Laid-Open No. 2008-52749).

In the constitution disclosed in Japanese Patent Application Laid-Open No. 2005-22062, the following control is performed. That is, first, the lattice points arranged in the robot arm arrangeable range are set as the arrangeable candidate points Qk (1≦k≦m). From the arrangeable candidate points Qk, only the points where the inverse kinematics can be solved, there is no interference with the peripheral device, and the margin of operation clears the reference value are left, thereby setting the provisionally arrangeable range. Then, the robot arm is arranged at each of the various points within the provisionally arrangeable range, the operation simulations are performed at the respective points, and the data for evaluating the arrangements of these points are collected. The collected data are evaluated respectively by checking them against the evaluation standards of several viewpoints. Moreover, the evaluation results for one or more viewpoints are evaluated by the evaluation function, and the optimum arrangement (in some cases, plural) is selected.

Besides, in the constitution disclosed in Japanese Patent Application Laid-Open No. 2008-52749, the following control is performed. That is, first, the plurality of arrangement candidate positions of the working target are specified, and then the robot arm movement path which passes through the predetermined position and each of the plurality of arrangement candidate positions is specified. Next, the movement of the robot arm in each of the robot arm movement paths is simulated, and the robot arm movement time which reflects the rotation angle of the robot arm at the time of the movement is acquired. Finally, the arrangement candidate position corresponding to the robot arm movement path, for which the robot arm movement time is shortest, is determined as the optimum arrangement.

In the method disclosed in Japanese Patent Application Laid-Open No. 2005-22062, from the lattice points acquired by dividing the arrangeable range in the workspace with an appropriate number, only the points where the inverse kinematics are solved, there is no interference with the peripheral device, and the margin of operation clears the reference value are left, thereby setting the provisionally arrangeable range. Then, the robot arm operation simulation is performed at all the lattice points in the provisionally arrangeable range, and thus the arrangement configuration is evaluated. Therefore, in a case where the optimum point exists between the lattice points, it is impossible to reach the optimum point. Thus, there is a possibility that the number of lattice points must be increased to improve accuracy.

As the number of the lattice points in the provisionally arrangeable range increases, the calculation time necessary to perform the evaluation becomes longer. In particular, when considering only the arrangement of the robot arm, the calculation time increases in proportion to the number of the arrangement candidates. Furthermore, when considering not only the arrangement of the robot arm but also the arrangement of the work piece and the peripheral device, since the combinations of such elements are equivalent to the product of the numbers of the respective arrangement candidates, there is a possibility that the calculation processing amount becomes enormous. For example, in a case where the arrangement candidates of the robot arm, the work piece and the peripheral device are represented respectively by 100 lattice points, 100×100×100=1000000 evaluations must be made.

That is, in the method disclosed in Japanese Patent Application Laid-Open No. 2005-22062, the efficiency of the evaluation calculation for the arrangement candidates is hardly taken into consideration. Therefore, there is a possibility that enormous computer resources are required depending on the scale of the target working environment or the like. Besides, in the constitution disclosed in Japanese Patent Application Laid-Open No. 2005-22062, the interference avoiding operation is not automatically performed, and the robot arm passes only the determined path. Therefore, for example, even if there is another path by which the target operation can be realized without interference, it might be determined that the operation is impossible with such an arrangement, so that there is a fear that optimality of the arrangement deteriorates.

Besides, in the method disclosed in Japanese Patent Application Laid-Open No. 2008-52749, as well as the method disclosed in Japanese Patent Application Laid-Open No. 2005-22062, the simulations are performed for all the arrangement candidate positions of the working-target object, and then the evaluation is performed based on the simulations. Therefore, as the number of the arrangement candidates of the work piece increases, the calculation time becomes longer. Besides, when considering the arrangement of the robot arm, there is a problem that it is necessary to evaluate the arrangement candidates of which the number is equivalent to the product of the number of the arrangements of the work piece and the number of the arrangements of the robot arm. Also, in the method disclosed in Japanese Patent Application Laid-Open No. 2008-52749, the interference avoidance operation is not automatically generated or evaluated. For this reason, as well as the case disclosed in Japanese Patent Application Laid-Open No. 2005-22062, also in the method disclosed in Japanese Patent Application Laid-Open No. 2008-52749, there is a possibility that enormous computer resources are required depending on the scale of the working environment or the like. Thus, there is a possibility that an optimum arrangement cannot be searched.

As described above, in the related art, since all the combinations of the arrangements of robot equipment are tried and evaluated, there is a problem that the calculation time is prolonged by such a method. Moreover, in the related art, there is a possibility that the optimum arrangement cannot be searched out sufficiently because the function of the automatic generation and evaluation of the interference avoidance operation is lacking.

In consideration of the above problems, an object of the present invention is to optimize the layout (arrangement) of the robot equipment at high speed by efficiently performing trajectory generation for avoiding interference of the robot arm and optimization of the layout of the robot equipment.

### SUMMARY OF THE INVENTION

In order to solve the above problems, in the present invention, there is adopted a layout setting method for a robot arm and a peripheral device in a robot workspace, the method comprising: a teaching point acquiring step of causing a controlling device to acquire a teaching point which corresponds to a specific operation that the robot arm accesses the peripheral device, and through which the controlling device allows a reference region of the robot arm to pass; an initial layout generating step of causing the controlling device to generate an initial layout of the robot arm and the peripheral device; a trajectory generating step of causing the controlling device to generate a trajectory of the robot arm based on the teaching point; a layout changing step of causing the controlling device to generate a new layout by changing an arrangement of the robot arm or the peripheral device based on the initial layout; and a layout setting step of causing the controlling device to set an evaluation value concerning fitness for the specific operation in the initial layout or the new layout, and set the initial layout or the new layout based on the set evaluation value.

Further features of the present invention will become apparent from the following description of exemplary embodiments with reference to the attached drawings.

### BRIEF DESCRIPTION OF THE DRAWINGS

FIG. 1 is an explanatory diagram for describing a robot arm and peripheral devices to which layout evaluation or an optimizing process of the present invention is applicable, or a display screen on which the robot arm and the peripheral devices are simulation-displayed by a layout optimizing apparatus.

FIG. 2 is a block diagram for describing a constitution of a layout optimizing apparatus to which the present invention is applicable.

FIG. 3 is a flow chart for describing a layout optimizing process according to a first embodiment of the present invention.

FIG. 4 is a flow chart for describing a layout initializing process according to the first embodiment of the present invention.

FIG. 5 is a flow chart for describing a layout optimizing process according to a second embodiment of the present invention.

FIG. 6 is a flow chart for describing a layout evaluating process according to the second embodiment of the present invention.

FIG. 7 is a flow chart for describing a process of updating a maximum evaluation value of a layout according to the second embodiment of the present invention.

FIG. 8 is a flow chart for describing a layout optimizing process according to a third embodiment of the present invention.

FIG. 9 is a flow chart for describing a process of updating position and fitness of a particle in a particle swarm optimizing process according to the third embodiment of the present invention.

FIG. 10 is a flow chart for describing a layout evaluating process according to the third embodiment of the present invention.

FIG. 11 is a flow chart for describing the layout evaluating process according to the third embodiment of the present invention.

### DESCRIPTION OF THE EMBODIMENTS

Hereinafter, preferred embodiments of the present invention will be described in detail with reference to the accompanying drawings. Incidentally, it should be noted that the following embodiments are merely examples, and, for example, the detailed constitutions of the embodiments can appropriately be modified or changed by a person skilled in the art without departing from the meaning of the present invention. In addition, the numerical values taken in the following embodiments are merely reference numerical values, and they do not limit the present invention.

### First Embodiment

The first embodiment of the present invention will be described hereinafter. In general, a robot arm is composed of a joint and a link mechanism. There are various kinds of joints such as a rotation joint, a prismatic joint, a ball joint and the like. As operations (motions) of a joint, there are an operation to be performed actively by a motor or the like, and an operation to be performed passively without any power source. Each of the joints is connected to another joint by a link mechanism. Here, as such link types, there are a serial link type in which the joints and the link mechanisms are alternately arranged in series, a parallel link type in which combinations of the joints and the link mechanisms are arranged in parallel, and the like. In the following, a robot arm of the serial link type having the rotation joints will be described as an example. However, it should be noted that the following control can be performed even when a robot arm of the parallel link type, or a robot arm having the prismatic joints is used.

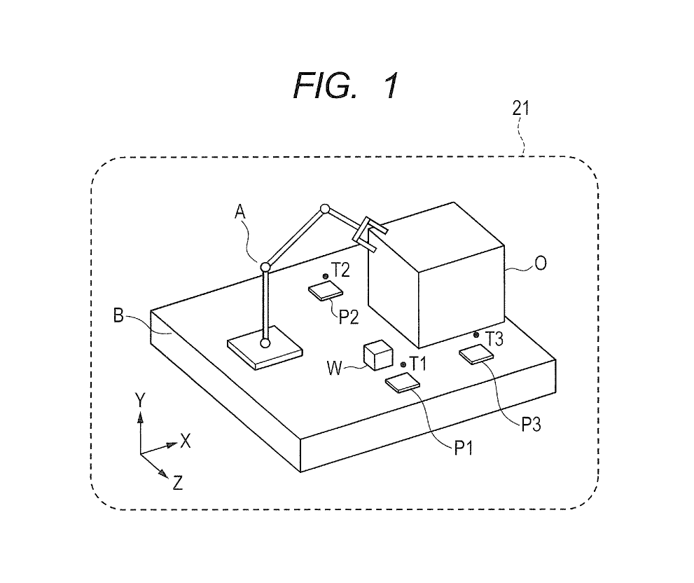

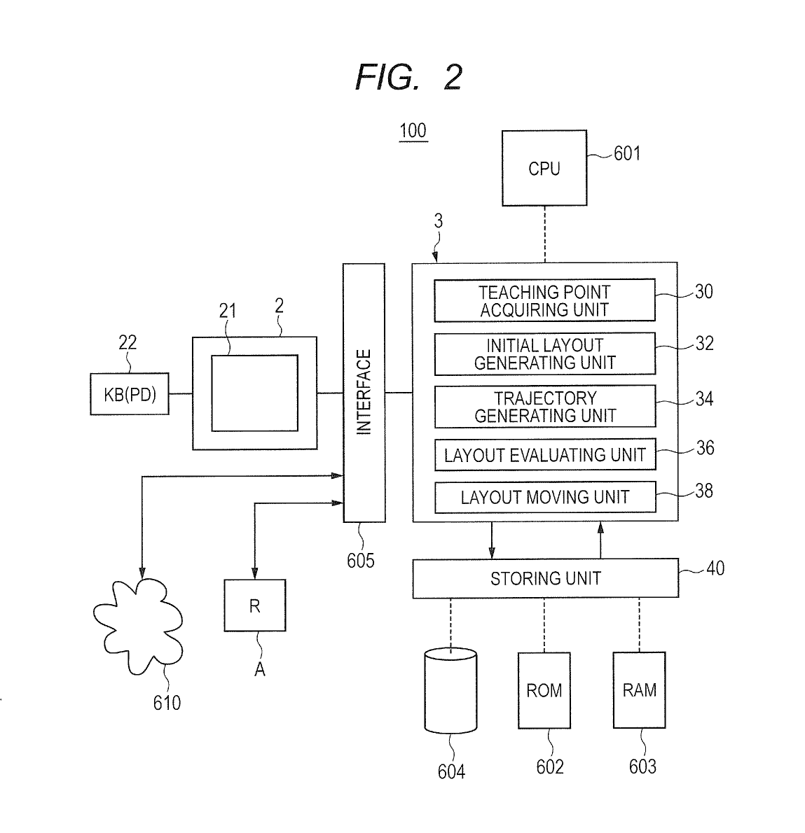

FIG. 1 is a diagram for describing a robot arm A and peripheral devices (work piece rests P1 to P3, a work piece W, and the like) of which a layout is evaluated by a layout optimizing apparatus 100 (FIG. 2) according to the present invention, or a display state of a display screen (21) on which the robot arm and the peripheral devices are simulation-displayed. FIG. 2 is the diagram for describing the constitution of the layout optimizing apparatus 100 which evaluates the layout of the robot arm A and the peripheral devices (the work piece rests P1 to P3, the work piece W, and the like), and acquires (determines) a layout which is suitable for a specific operation that the robot arm accesses the peripheral device.

FIG. 1 illustrates the state that the robot arm A, the work piece W, the work piece rests P1, P2 and P3, an obstacle O and the like are respectively arranged (or laid out) on a base B corresponding to a workspace (robot workspace) of the robot arm A. Here, it is assumed that the robot arm A has three joints (i.e., a three-shaft articulated robot arm), and a hand at the tip thereof for grasping (or gripping) an object such as a work piece (work) for which working is performed.

Incidentally, the robot arm A generally has only to be widely conceived as an operation (motion) body which itself operates or moves, and the present invention is not limited by the constitution of the robot arm A in particular. For example, although only one robot arm A is illustrated in FIG. 1, the following control can be realized even in a case where two or more six-shaft articulated robot arms are arranged.

The layout in the present embodiment is a layout configuration (or an arrangement) in which, for example, the robot arm A, the work piece W, the work piece rests P1 and P2 and the obstacle O are arranged in a certain positional relationship in the robot workspace, as illustrated in FIG. 1. More specifically, the layout is a generic name of the positions and orientations of these elements.

The layout optimizing apparatus 100 (FIG. 2) has almost the same hardware constitution as that of a device such as a robot simulator. In particular, the layout optimizing apparatus 100 comprises a display 21 having a displaying device such as an LCD (liquid crystal display) panel or the like, and can display the state of a working environment on the base B in an appropriate 3D display format. For example, as indicated by the broken line (21) of FIG. 1, FIG. 1 may be considered to illustrate a simulation (3D) display of the robot arm A and the peripheral devices (the work piece rests P1 to P3, the work piece W, and the like) on the display 21 of the layout optimizing apparatus 100.

In FIG. 2, the layout optimizing apparatus 100 corresponds to a layout setting apparatus which performs a layout setting method according to the present embodiment. The layout optimizing apparatus 100 comprises the display 21 which can perform simulation (3D) display of a working environment of a robot. Therefore, for example, the layout optimizing apparatus may comprise, in addition to a function for performing a later-described layout evaluating process, a function for programming, correcting and evaluating control (teaching) data of causing the robot arm A to operate or move in a similar working environment. Since various functions which utilize this kind of simulation (3D) display are well known, a detailed description thereof is omitted here.

In addition to the display 21, the layout optimizing apparatus 100 also comprises an operation unit 2 (i.e., a user interface) for causing an operator to input various data, a calculation processing unit 3 for performing layout evaluation or an optimizing process, and a storing unit 40 for storing various data.

The display 21 constitutes the operation unit 2 together with an operation device 22. As a device to be used as the operation device 22, a keyboard (KB), a pointing device (PD) such as a mouse, a track pad (ball) and a digitizer pad, and the like are conceivable.

The calculation processing unit 3 comprises calculation (control) functions which are indicated by function blocks of a teaching point acquiring unit 30, an initial layout generating unit 32, a trajectory generating unit 34, a layout evaluating unit 36 (i.e., a layout setting unit), and a layout moving unit 38 (i.e., a layout changing unit). Actually, each of the above “units” (30, 32, 34, 36 and 38) of the calculation processing unit 3 is realized by causing a CPU (central processing unit) 601 to perform a process (control program) as described in a later-described flow chart. Therefore, each “unit” (30, 32, 34, 36 and 38) may be read as “process” (30, 32, 34, 36 and 38).

The storing unit 40 is actually constituted by using a ROM (read-only memory) 602, a RAM (random access memory) 603, and an external storing device 604 such as an HDD (hard disk drive) or an SSD (solid-state drive) (or another memory device), which can be accessed by the CPU 601. A memory (variable, constant) area to be used for later-described control (process) is arranged on each of these storing devices (602 to 604). Besides, the memory (variable, constant) area to be used for the later-described control (process) may not be permanently allocated to a specific address of a specific storing device. For example, in an OS (operating system) environment in which the CPU 601 executes a program, there is a case where a virtual storing area constituted by combining the RAM 603 and the external storing device 604 can be used. When using the virtual storing area like this for the above memory (variable, constant) area, the specific memory (variable, constant) area is fluidly controlled in accordance with a use state of the memory.

Besides, a part of the storing unit 40 may include a computer-readable recording (storage) medium (for example, a detachably attachable recoding medium) which stores therein a control program describing a control procedure to be executed by the later-described CPU 601. As the recording medium like this, the external storing device 604, a storing device such as an EPROM (erasable programmable read-only memory) or an EEPROM (electrically erasable programmable read-only memory) arranged in a part of the ROM 602, an optical disk or a magneto-optical disk to be used in an optical drive, and the like are conceivable.

The calculation processing unit 3 (the CPU 601, the ROM 602, the RAM 603, the external storing device 604, . . . ) is connected to an external device via an interface 605 in terms of hardware. In FIG. 2, the above operation unit 2 (the display 21, the operation device 22) is connected to the interface 605. In addition, a network 610 and the robot arm A (or its robot controlling apparatus) may be connected to the interface 605. In a case where a function for generating robot teaching data is provided using a graphical environment in which the operation unit 2 is used, for example, the generated robot teaching data can be transmitted to the robot arm A (or its robot controlling apparatus) via the interface 605. Besides, the robot arm A may be connected via the network 610. The network 610 can also be used for communication of other external devices (a robot arm, a server device, or another layout setting apparatus). In addition, it is also possible to download a later-described control program via the network 610, and install the downloaded control program in a predetermined area of the ROM 602, the external storing device 604 or the like. Further, it is possible to update a part or all of the installed programs.

Incidentally, although the interface 605 is illustrated as one block here for simplicity, the interface is actually constituted by an interface device corresponding to an apparatus to be connected. For example, an interface which is constituted by various serial and parallel buses is used for connection with the robot arm, and a network interface which is constituted by various wired and wireless connection systems is used for connection with the network 610.

The teaching point acquiring unit 30 of the calculation processing unit 3 is a unit (means) for acquiring a teaching point for setting an orientation of the robot arm A. In later-described layout optimization, the teaching point acquiring unit searches for a layout which is suitable for a specific operation to be performed by the robot arm A.

The teaching point acquiring unit 30 is for acquiring the teaching point corresponding to the specific operation to be performed by the robot arm A, and it is conceivable to use, for example, a user interface constituted by the operation device 22 and the display 21 of the operation unit 2. For example, an operator is caused to operate the robot arm A which is 3D-displayed on the display 21, by using a pointing device or the like of the operation device 22. Then, the teaching point acquiring unit causes to repeatedly move a reference region (e.g., a hand tip position) of the robot arm A to a desired position and perform a specific determination operation, and then stores as the teaching point the position through which each reference region is caused to pass.

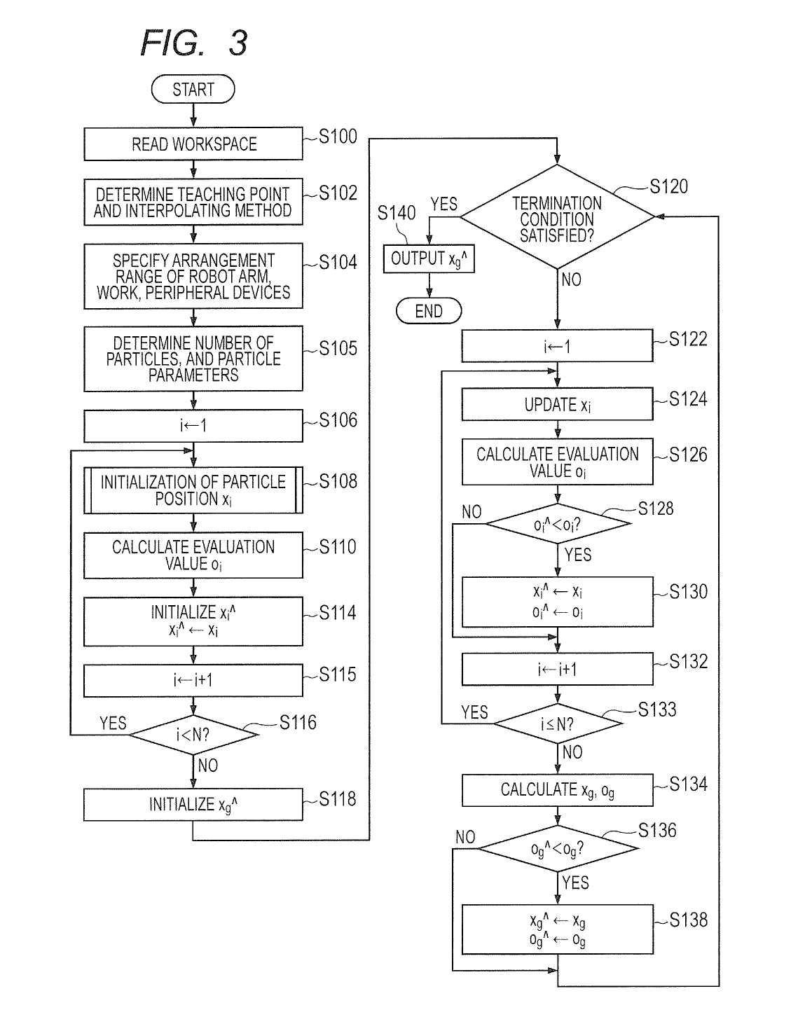

Incidentally, the teaching by the teaching point acquiring unit 30 is performed (only) once before a layout to be evaluated is generated, as described later (for example, S102 in FIG. 3). In many of the generated layouts, since the arrangement of each part of the robot arm A and the peripheral devices (the work piece rests P1 to P3, the work piece W, and the like) is different from others, it is not realistic to perform teaching by the teaching point acquiring unit 30 in regard to all of these layouts.

For example, in a case where the above interface using a GUI (graphical user interface) is used as the teaching point acquiring unit 30 before the layout to be evaluated is generated, it is possible to cause an operator to lay out (or arrange) each of the above parts at an appropriate position and perform the teaching operation. In such a case, for example, if later-described local coordinates are used as the value of the teaching point to be input, it is possible to generate a teaching point group which corresponds to the specific operation that it wishes to cause the robot arm to perform, and which the specific operation is also applicable to a different layout.

As a method of representing the teaching point of the robot arm A, there is a method of using a position and orientation of the reference region of the arm (for example, the hand tip of the robot arm A). The teaching point itself is not fixed to a robot arm coordinate system, but the relevant teaching point can be specified by a world coordinate system set in the entire working environment, a local coordinate system fixed to the peripheral devices, and the like. Generally, in this kind of robot control, an arbitrary coordinate system such as the above world coordinate system, the local coordinate system or the like is used depending on control convenience. Further, if necessary, the calculation processing unit 3 (the CPU 601) can mutually convert the coordinate values of each coordinate system by using appropriate homogeneous transformation matrix calculation.

For example, in case of realizing an operation to place the work piece W on the work piece rest, the teaching point is set such that the hand tip of the robot arm comes to a position above the work piece rest. In this case, even if the work piece rest moves, it is desirable that the teaching point is moved together with the work piece rest while maintaining the relative position between the work piece rest and the teaching point. Therefore, when the teaching point of the hand tip of the robot arm A is specified, it is more convenient in the process if it is possible to specify the teaching point in the coordinate system which is fixed to the movement object such as the work piece rest.

Incidentally, to acquire the concrete orientation of the robot arm by calculating each shaft joint angle of the robot arm from the teaching point of the hand tip of the robot arm, an inverse kinematics calculation is performed. For example, when the robot arm A of FIG. 1 is given with a teaching point T1 indicating the position and orientation of the hand tip, joint angles (θ1, θ2 and θ3) of the robot arm A are calculated such that the hand tip position of the robot arm A comes to the position and orientation of the teaching point T1. Besides, the initial layout generating unit 32 illustrated in FIG. 2 is a unit (means) for generating an initial value of the layout to be used when performing the layout optimization. For example, when the positions and orientations of the robot arm A, the work piece W, and the work piece rests P1, P2 and P3 are movable, for example, the operator inputs and sets the positions and orientations thereof using the operation unit 2. Alternatively, the initial value of the layout may be set by the CPU 601 using a random (random number) calculation or the like. Besides that, it is also possible to set the optimization result at the time of the previous optimization as the initial layout.

The trajectory generating unit 34 comprises a unit (means) for generating an operation (motion) path of a robot arm and a unit (means) for generating a trajectory of instructing the joint value of the robot arm for each certain unit time on the path. The operation path of the robot arm represents the trajectory of the operation (motion) of the robot arm, but the operation path does not include any time concept such as speed here. Trajectory data for instructing the joint value of the robot arm for each certain unit time includes information of the operation speed of the robot arm. As a means for generating a path, there is a method of generating a path by which a start point and a target point while avoiding interference.

As such path generating methods, there are many methods such as a potential method, a PRM (Probabilistic Roadmap Method), an RRT (Rapidly-exploring Random Tree) and the like. The present invention is not limited by an embodiment of a path generating unit. That is, for example, it is also possible to use other path generating methods such as a visible graph method, a cell dividing method, a Voronoi diagram method, and the like.

Incidentally, since the path generated by the method as described above is wasteful because it often includes roundabouts and/or pointed portions, there is a case where path correction is necessary. Therefore, for example, the trajectory generating unit 34 may further comprise a function for a path shortening process to perform the above path correction. More specifically, in a case where an interpolation point is newly added to the path generated by the path generating unit and there is no interference with a peripheral environment on the straight line connecting two arbitrary points with each other, it may be possible to adopt a method of repeatedly performing an operation of newly replacing the path between the two points with the straight line as the path.

The trajectory generating unit 34 calculates a change rate (speed) of the joint angle of the robot arm with respect to the path calculated by the above path generation, and generates the trajectory which instructs the joint value of the robot arm for each certain unit time. Here, the trajectory represents displacement and speed of the orientation of the robot arm as a function of time.

For a trajectory generating method, a shortest time controlling method of calculating an optimum speed of the robot arm is known. Such shortest time control is configured so as to solve an optimization problem. Here, for example, the optimization problem is to shorten the time to a path determined by a path interpolating unit while keeping physical constraints related to joint torque, joint angle speed, joint angle acceleration, TCP (tool center point) speed, TCP acceleration and the like.

Further, when a path for avoiding interference is generated by the trajectory generating unit 34, it is necessary to decide whether or not objects interfere with each other. For example, in a case where the 3D CAD data of the robot arm A and the obstacle O are represented as sets of polygons (for example, polygons such as triangles), it is determined whether or not the set of the polygons of the current orientation of the robot arm A and the set of the polygons of the obstacle O are geometrically in contact with each other. Here, it is not always necessary to use a polygon format for representing 3D CAD data, that is, so-called voxel representation data may be used.

The layout evaluating unit (layout setting unit) and the layout moving unit 38 (layout changing unit) generate and optimize the layout (arrangement) of the robot arm A, the work piece W, and various peripheral devices. In the present embodiment, it is preferable in that case to efficiently generate and optimize the layout by using a meta-heuristic calculation, especially a particle swarm optimization technique.

The layout evaluating unit 36 (layout setting unit) sets an evaluation value concerning fitness with respect to the specific operation that the robot arm accesses the peripheral device in the robot workspace, and, based on the set evaluation value, sets an initial layout or a new layout generated by the layout moving unit 38 (layout changing unit) as the layout.

In the present embodiment, for example, the robot arm A, the work piece W and the peripheral device are arranged at respective points within the arrangement range specified by the initial layout, an interference avoidance trajectory is generated there, and the arrangement of those points is evaluated from various viewpoints. Then, by updating the position and the speed of “particle” in the particle swarm optimization calculation from the evaluation value, the arrangement of the robot arm A, the work piece W and the peripheral device is shifted toward the best arrangement. After then, when a predetermined number of times or a predetermined evaluation value is exceeded, the best arrangement at that time point is output as the optimum arrangement.

As the evaluation value, for example, it is possible to use (1) the time during which the robot arm A operates or moves in the trajectory generated by the trajectory generating unit 34, (2) the interference amount between the robot arm A and another peripheral device or obstacle O, (3) the number of times that the trajectory enabling to avoid the interference between the robot arm A and another peripheral device or the obstacle O could be generated by the trajectory generating unit 34, and (4) the number of the teaching points for which the inverse kinematics calculation of the robot arm A is established with respect to each of the teaching points acquired by the teaching point acquiring unit 30.

Here, the meta-heuristic calculation, particularly the particle swarm optimization calculation to be used in the present embodiment, will be described. Such a particle swarm optimizing process is generally classified as a process stage of calculating swarm intelligence. Here, the swarm intelligence is an artificial intelligence technique based on the study of collective behaviors of decentralized and self-organized systems.

Generally, in the swarm intelligence or the particle swarm optimizing process, particles consist of simple agent populations, and each individual of the population operates or works by using both information of the individual itself and information of the population. In this case, contingency acts on the behavior of each individual, and also an influence of an interaction between the individuals acts on the behavior of each individual. Therefore, in such a swarm intelligence operation (process), a so-called metaheuristic (heuristic or learning) operation stage is used, for example, such that a process of generating a next state from a state of a certain swarm is repeated.

There is usually no centralized control structure which orders how individual agents should act, but such interaction between the agents often results in emergence of overall behaviors. As examples in a nature world of such a swarm intelligence system, there are an ant colony, a bird flock, an animal flock, a bacteria colony, a fish flock and the like. In particular, arithmetic methods such as ant colony optimization, cuckoo search, and particle swarm optimization are known as algorithms for emulating the swarm intelligence system existing in the natural world.

In the present embodiment, the particle swarm optimization calculation is used for layout generation and optimization. Here, the particle swarm optimization (PSO) is a kind of swarm intelligence. For example, in an insect swarm or a fish swarm, if one finds a good movement path (route) which fits a certain purpose (e.g., a food discovery, a natural enemy avoidance behavior, or the like), the rest of the herd can quickly follow the one regardless of locations.

The particle swarm optimization calculation is to model, in a multidimensional space, such a behavior of the swarm intelligence by means of the particle swarm having a position and speed. The particle defined by the particle swarm optimization calculation flies about in a space and searches for the best position. Here, it is determined whether or not a certain position is the best, by an evaluation function created according to a purpose of a calculation model of such a particle swarm. The members of the swarm mutually exchange information about good positions, and adjust their positions and speeds based on the exchanged information. For example, such communication is performed by that a particle i which is at the best position is notified to the whole.

The representative operational expressions (1) and (2) for the particle swarm optimization calculation are as follows. In the particle swarm optimization, the particle to be evaluated has information indicating a position xᵢ and a speed vᵢ. The position xᵢ and the speed vᵢ are updated by the following expressions (1) and (2), and such an update is repeated. Here, “←” indicates substitution.

xᵢ←xᵢ+vᵢ (1)

vᵢ←wᵢvᵢ+c₁ᵢr₁ᵢ(\hat{x}ᵢ−xᵢ)+c₂ᵢr₂ᵢ(\hat{x}_{g}−xᵢ) (2)

In the expression (2), wᵢ is an inertial constant, and, in many cases, a value slightly smaller than 1 is optimum. Also, each of c₁ᵢ and c₂ᵢ is a proportion of the particles going to a good position in the swarm, and, in many cases, a value close to 1 is optimum. Each of r₁ᵢ and r₂ᵢ is a random number having a value within the range of [0, 1] (0 to 1).

In the mathematical expressions and the text of this specification, the suffix i is used to mean the information of the particle i. However, in the attached flow charts, for convenience, a normal notation which is not the suffix as above may be used in some cases. Also, in this specification, “̂” (hat) in the expressions indicates optimized data. For example, xᵢ̂ corresponds to the best position discovered so far by the relevant particle, and x_{g}̂ corresponds to the best position discovered so far in the entire swarm. Incidentally, the “̂” (hat) which is written above the character in the image of mathematical formula (expression (2)) shall be written after the character as above in the text or the flow charts, as a matter of convenience. Further, in the following, oᵢ̂ is the highest evaluation value so far for the particle alone, o_{g}̂ is the highest evaluation value so far for all the particles, and N is the number of the particles.

In case of analyzing the behavior of the swarm of organisms such as fish, insects and the like, the above “particle” is associated with one of the individuals of the organisms. In the present embodiment, to utilize the particle swarm optimization for layout generation and evaluation in a robot working environment, a specific arrangement state (layout) of the robot arm A, the peripheral devices (the work piece rests P1 to P3, the work piece W, and the like) is associated with one particle.

That is, in the present embodiment, the position xᵢ of the particle i in the particle swarm optimization is given by representing the position and orientation of the robot arm A (not-illustrated robot arm fixing base F) and the positions and orientations of the work piece rests P1, P2 and P3 with one vector. Besides, the speed vᵢ is given by representing the speed of the robot arm fixing base F and the speeds of the work piece rests P1, P2 and P3 with one vector.

For example, the evaluation of a specific particle (specific layout) is performed by using the evaluation value concerning fitness to a specific working (operation) that it wishes to cause the robot arm A to perform and that accesses the peripheral device (for example, an operation of moving the work piece W between arbitrary positions of the work piece rests P1, P2 and P3). More specifically, the evaluation is performed depending on a speed or a required time for the relevant operation. Moreover, in the evaluation of the specific particle (specific layout), it is also considered whether or not the intended robot operation is possible as the inverse kinematics, whether or not the intended robot operation can be performed after avoiding the obstacle O, and the like.

FIG. 3 the flow chart for describing a main control procedure of the layout optimization according to the present embodiment. The control procedure described below is realized on the premise that the calculation processing unit 3, in particular, the CPU 601 which is the control core thereof, executes the control program describing the control procedure of the present embodiment. The relevant control program can be stored in the ROM 602, the external storing device 604, or the like.

Here, in the layout optimization of the present embodiment, it is assumed that the robot operation (that is, the specific operation that the robot arm accesses the peripheral device) to be performed by the robot arm A is as follows.

For example, in the arrangement as illustrated in FIG. 1, the robot arm A grips the work piece W, and moves it from the teaching point T1 fixed to the work piece rest P1 to a teaching point T2 fixed to the work piece rest P2 while avoiding interference with the obstacle O. Subsequently, the robot arm A grips the work piece W, and moves it from the teaching point T2 fixed to the work piece rest P2 to a teaching point T3 fixed to the work piece rest P3 while avoiding interference with the obstacle O. In the evaluation of the specific particle (specific layout), in the present embodiment, on the condition that the above specific robot operation can be performed as the inverse kinematics and can also be performed while avoiding the obstacle O, the required time (speed) thereof is evaluated.

In the layout optimization of the present embodiment, the layout suitable for performing the relevant specific robot operation is acquired. Namely, the positions and orientations of the optimized robot arm A fixing base F and the work piece rests P1, P2 and P3 are acquired.

Initially, in S100 of FIG. 3, the three-dimensional shape of the workspace on the base B, position and shape information of the robot arm A, the robot arm fixing base F, the obstacle O, the work piece W and the work piece rests P1, P2 and P3 are acquired.

Among them, the shape information of the robot arm A, the robot arm fixing base F, the obstacle O, the work piece W, the work piece rests P1, P2 and P3 are, for example, design information, and, for example, the design information can be set by three-dimensional CAD data (3D data) or the like. As the shape (design) information of these things, for example, data recorded in another server or the like can be received via the network 610. Besides, the shape (design) information of these things may be set using video images captured in advance by a camera (not illustrated), data collected by measurements using various sensors, or the like.

Next, in S102, the teaching point corresponding to the specific operation to be performed by the robot arm A and an interpolating method to be performed when generating the trajectory based on the teaching point are set and determined (teaching point acquiring step). The teaching point of the robot arm A is determined by inputting the position and orientation of the hand tip with use of the teaching point acquiring unit 30. At this time, as described above, for example, there is used the method in which an operator inputs the position and orientation by moving the hand tip with the robot arm A which is 3D-displayed on the display 21 by the pointing device or the like of the operation device 22. Besides, the interpolating method is to specify what kind of interpolating method to interpolate the trajectory up to a specific teaching point. For example, such an interpolating process includes joint space interpolation, linear interpolation, circular interpolation, and the like. For selection of the interpolating process, selection of a GUI menu using the display 21 of the operation unit 2 and the operation device 22, a command line interface, or the like may be used. Here, it is assumed that it is specified to move the trajectory to the teaching points T1, T2 and T3 by joint interpolation.

In S104, a range of the positions and orientations of the fixing base F of the robot arm A, and the peripheral devices (peripheral equipment), that is, the work piece rests P1, P2 and P3 is specified. For example, when the range of the position and orientation of the fixing base F of the robot arm A is specified, it is conceivable to specify the upper limit and the lower limit of a coordinate parameter on a task space (i.e., the working environment on the base B: same hereunder). Here, the position of the fixing base F of the robot arm is represented by, for example, x, y and z in the task space, and rotation amounts α, β and γ around the respective axes as ZYX Euler angles. Then, the arrangement range of each of the coordinate values and the Euler angles is set within a range between the minimum value and the maximum value as follows, that is, the range from the lower limit (min) to the upper limit (max) of each of xₘᵢₙ<x<xₘₐₓ, yₘᵢₙ<y<yₘₐₓ, zₘᵢₙ<z<zₘₐₓ, αₘᵢₙ<α<αₘₐₓ, βₘᵢₙ<β<βₘₐₓ, and γₘᵢₙ<γ<γₘₐₓ. Likewise, the upper and lower limits of coordinate parameters in the task (working) space on the base B are also specified for each of the work piece rests P1, P2 and P3.

In S105, the number N of the particles in the particle swarm optimization is determined, and also the parameters wᵢ, c₁ᵢ, c₂ᵢ, and r₂ᵢ of the particle i are determined as much as the number of the particles. These parameters may be input by the operator from the operation unit 2, or previously selected fixed values may be used as these parameters.

In S106, a loop variable i for controlling the loop of S108 to S116 is initialized to 1. In the loop of S108 to S116, the loop variable i is changed from i=1 to N, and a layout corresponding to each of the N particles i is generated.

In S108, the initial layout generating unit 32 initializes the position xᵢ of the particle. Here, for example, xᵢ may be initialized with a random value, or by using a result optimized under other conditions. In any case, the initialization is performed using the coordinate value within the arrangement range specified in S102.

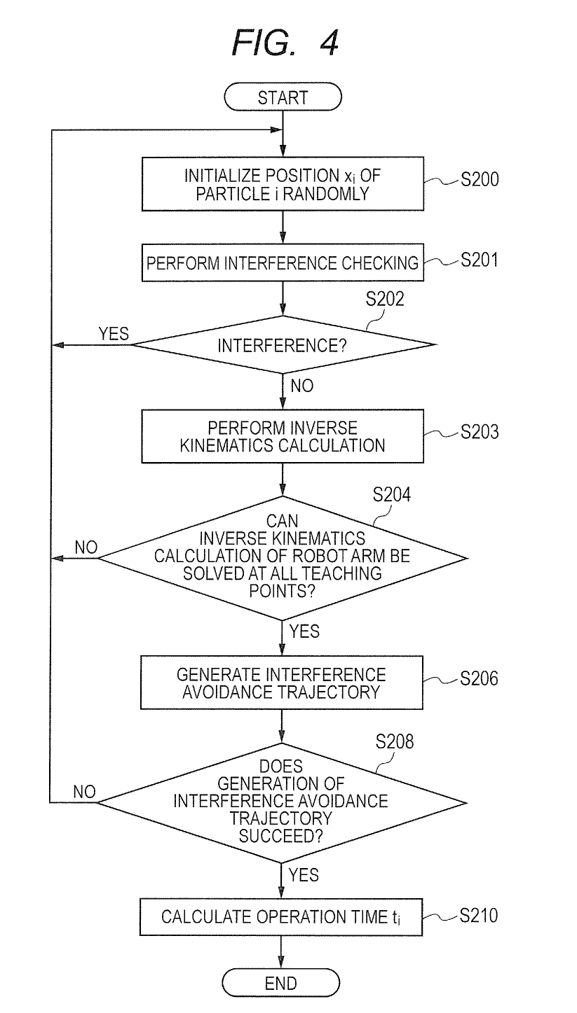

In the first embodiment, since the evaluation of the layout is performed only based on the operation time of the robot arm, in the initial layout generating process (S108) of FIG. 4, the arrangement (xᵢ: position) of the particle corresponding to the layout is generated as follows. That is, the initialization is performed with the layout in which the robot equipment does not interfere with another robot equipment, the robot arm can solve the inverse kinematics and takes the orientation not exceeding the joint angle limit of the robot arm at the teaching point, and the path for avoiding the interference can be generated.

The initial layout generating process in S108 is performed according to a flow chart as illustrated in FIG. 4 (initial layout generation step). In S200 of FIG. 4, the position xᵢ of the particle i is randomly initialized. That is, a vector (xᵢ), which represents the layout, that is, the position and orientation of the robot arm A (robot arm fixing base F) and the positions and orientations of the work piece rests P1, P2 and P3, is generated using an appropriate random processing calculation.

In S201 and the following steps, the layout corresponding to the position xᵢ of the particle i acquired in the initialization of S200 is evaluated.

First, in S201, in the layout of xᵢ, an interference checking calculation is performed as to whether the robot arm A, the fixing base F of the robot arm A, the work piece W, the work piece rests P1, P2 and P3 and the obstacle O interfere with others. However, in the state (process) in which the robot arm A is gripping the work piece W, the interference checking between the robot arm A and the work piece W is not performed.

In S202, when it is determined that the interference has occurred as a result of the interference checking in S201, the process returns to S200 to newly generate another layout (particle xᵢ).

In S203, the inverse kinematics calculation of the robot arm A is solved from the given teaching points T1, T2 of T3 of the hand tip. That is, the inverse kinematics calculation for calculating the position of each joint of the robot arm A (its rotation angle in the case of the rotation joint) when the robot arm A moves the reference region such as the hand tip or the like to the teaching points T1, T2 and T3. In general, the length of the link of the robot arm A is fixed. In each joint, for example, a joint movable range is defined. The inverse kinematics calculation in S203 is performed by using the conditions of the dimensions of each link, and performed to acquire the position of each joint realizing the corresponding teaching point within the movable range of each joint.

In S204, it is determined whether or not the inverse kinematics calculation in S203 has been solved. When the inverse kinematics calculation has been solved, that is, when the position of each joint of the robot arm A realizing the corresponding teaching point has been acquired, the process advances to S206. On the other hand, when the arm cannot take its orientation because, for example, the calculated position of any joint of the robot arm A (its rotation angle in the case of the rotation joint) exceeds the movable range, it is determined that the inverse kinematics calculation could not be solved. Here, the case where the inverse kinematics calculation cannot be solved includes a case where the hand tip of the robot arm A does not reach the teaching point, or the like. In this case, the process returns to S200 to newly generate another layout (particle xᵢ).

In S206, the trajectory generating unit 34 generates the interference avoidance trajectory (trajectory generating step). More specifically, from a specified teaching point list, the interference avoidance trajectory capable of avoiding the interference with each peripheral device, the obstacle O and the like is generated. Generally, in robot control, for example, an avoidance path generation technique such as the RRT or the like is known. Thus, the interference avoidance trajectory is generated by performing interpolation between the teaching points respectively indicating the start and end points and thereafter performing again interpolation to form a trajectory line including movement speed information of the robot arm, such that the robot arm avoids the interference with the peripheral device and the obstacle O.

In the specific operation to be used in the present embodiment, in the environment of FIG. 1, the robot arm A grips and moves the work piece W from the teaching point T1 fixed to the work piece rest P1 to the teaching point T2 fixed to the work piece rest P2, while avoiding the interference with the obstacle O. Thereafter, the robot arm A grips and moves the work piece W from the teaching point T2 fixed to the work piece rest P2 to the teaching point T3 fixed to the work piece rest P3, while avoiding the interference with the obstacle O. In the present embodiment, the operation trajectory is generated for the specific operation like this.

In S208, a generation result of the interference avoidance trajectory in S206 is determined. For example, if at least one interference avoidance trajectory cannot be generated, the process returns to S200 to newly generate another layout (particle xᵢ). Also, when the number of trials exceeds a threshold by a path search algorithm such as the RRT, it may be determined that the generation of the interference avoidance trajectory has failed.

In S210, an operation time tᵢ of the specific operation to be performed by the robot arm A is calculated based on the generated interference avoidance trajectory. Here, with respect to joint driving of the robot arm A, conditions such as the upper limits of driving control values of a motor and a speed reducer (both not illustrated) incorporated in the joint are used. Besides, for example, acceleration of the joint and the upper limit value of the acceleration can be used for the purpose of vibration reduction or the like.

As in FIG. 4, the operation time tᵢ of the specific operation to be performed by the robot arm A with the specific layout (particle (xᵢ)) randomly generated is calculated. In this case, only particles for which there is no interference, for which the inverse kinematics calculation can be performed, and for which the avoidance trajectory can be generated, are left by initialization, and the operation time tᵢ of the specific operation in the layout thereof is calculated.

Thereafter, in S110 of FIG. 3, an evaluation value oᵢ of the layout of the particle i is calculated, for example, by the following expression (3).

oᵢ←1/(1+tᵢ) (3)

In the expression (3) for calculating the evaluation value oᵢ of the layout of the particle i, the operation time tᵢ is made to act on the denominator, so that the evaluation value oᵢ becomes higher as the operation time tᵢ required for the specific operation is shorter.

In S114, the best position xᵢ̂ of the particle i is initialized with xᵢ. In S115, the loop variable i is incremented by 1. In S116, it is determined whether or not the loop variable i is lower than N (loop continuation condition). In S116, when the value of the loop variable i exceeds N, that is, when the loop of S108 to S116 is performed N times, the process advances to S118. In S118, the position x_{g}̂ having the highest evaluation value among all the particles is initialized by the position xᵢ of the particle i with the highest evaluation value oᵢ in i=1 to N.

In S120, it is determined whether or not a termination condition of the optimization is satisfied. For example, the termination condition is determined based on whether or not the evaluation value o_{g}̂ which was the highest overall up to now exceeds a previously input (set) target value (a threshold of the evaluation value). Then, when the termination condition is not satisfied in S120, the process advances to S122. On the other hand, when the termination condition is satisfied in S120, the layout corresponding to the optimum position (x_{g}̂) is output in S140, and the layout optimization is terminated.

In the optimum layout output in S140, the state that the robot arm A and the peripheral devices (the work piece rests P1 to P3) are arranged at the positions corresponding to the relevant layout is output by 3D display (3D output) with the display 21 of the operation unit 2. Alternatively, the relevant state may be 3D-output by print output using a not-illustrated printer or the like. Alternatively, each coordinate value of the robot arm A and the peripheral devices (the work piece rests P1 to P3) corresponding to the optimum layout may be numerically output (displayed/printed). Here, such numerical values may be output so as to be superimposed at an appropriate position in the 3D display.

Besides, when the layout corresponding to the particle i is generated by a random process in the above loop of S108 to S116 or the like, the robot arm A and the peripheral devices (the work piece rests P1 to P3) in the relevant layout may simultaneously be 3D-output. That is, when the initial layout generation, the layout update and the trajectory generation are being performed, the state of the arrangement configuration of the robot arm A and each peripheral device and the position and orientation of the robot arm in the robot workspace are 3D-output (display or print) in real time. With such 3D-output, it is possible for the operator to confirm the state of the layout optimizing process.

When the termination condition of the optimization is not satisfied in S120, the loop (S122 to S133) for updating the optimum values (xᵢ̂, oᵢ̂) of the position and the evaluation value is performed while updating the position (xᵢ) of the particle i. First, in S122, the loop variable i is initialized to 1.

In S124, xᵢ is updated according to the expressions (1) and (2). That is, the value of the speed vᵢ of the particle i is updated by the expression (2), and the position xᵢ of the particle i is updated to a new position xᵢ based on the updated value. Thus, the layout corresponding to the particle i is updated to a new layout in which the relevant layout is changed as a start point. Then, in S126, in the relevant updated layout, as well as S110, the evaluation value oᵢ of the particle i is calculated.

In S128, oᵢ̂ which is the best evaluation value so far is compared with oᵢ calculated in S126. When oᵢ is higher than oᵢ̂, xᵢ is substituted for xᵢ̂ and oᵢ is substituted for oᵢ̂ in S130. That is, when the evaluation value oᵢ is high in the newly updated layout, xᵢ̂, i.e., the optimum value xᵢ̂ of the position (xᵢ) of the particle i, is updated with xᵢ, and the optimum value oᵢ̂ of the evaluation value is updated with oᵢ.

In S132, the loop variable i is incremented by 1, and, in S133, it is determined whether or not the loop variable i is equal to or lower than N (loop continuation condition). When the loop variable i is equal to or lower than N, the process returns to S124 to repeat the above processes. On the other hand, when the loop variable i exceeds N, the process advances to S134.

When the above loop (S124 to S133) is terminated, in S134, the maximum value among oᵢ acquired in the relevant loop is substituted for o_{g}, as indicated by the following expression (4).

o_{g}←maxᵢoᵢ (4)

That is, such a calculation operation updates x_{g} at the position xᵢ of the particle i at which oᵢ becomes maximum.

In S136, o_{g}̂ and o_{g} are compared with each other. Here, when o_{g} is larger than o_{g}̂, the process advances to S138 to update x_{g}̂ to x_{g}, update o_{g}̂ to o_{g}, and then returns to S120. When the termination condition is satisfied in S120, the optimum layout is output in S140 in the manner as described above.

As described above, according to the present embodiment, it is possible to efficiently and at high speed calculate the layout and the operations of the robot arm A (the fixing base F thereof) and the peripheral devices (the work piece rests P1, P2, P3 . . . ), suitable for the specific operation (predetermined process) that the robot arm A accesses the peripheral device. In addition, it is possible to efficiently and at high speed manufacture parts of various industrial products and the like, by a robot system which includes the robot arm and the peripheral device arranged based on the optimum layout set by the layout optimizing process according to the present embodiment. In that case, the teaching point acquiring unit 30 sets a teaching point line corresponding to an assembling work piece of the actual work piece W (part), and thus performs the above layout optimizing process. Thus, it is possible to determine a layout which is optimum for the assembling work piece of the specific work piece W (part). Therefore, it is possible to provide a part manufacturing method which can cause the robot arm A to efficiently perform the assembling work piece and robot system which comprises the robot arm A capable of efficiently performing the assembling work piece.

Incidentally, there has been described in the present embodiment the example that the meta-heuristic calculation, especially the particle swarm optimization being one of the swarm intelligence, is used for the update necessary to generate and optimize the layout of the robot arm A (the fixing base F thereof) and the peripheral devices (the work piece rests P1, P2, P3 . . . ). However, the method of optimizing the layout of the robot working environment is not limited to the particle swarm optimization. Namely, for example, other optimization calculating methods known as ant colony optimization, cuckoo search, and the like may be used. In that case, as well as the present embodiment, it only has to associate the positions and orientations of the robot arm A (the fixing base F thereof) and the peripheral devices (the work piece rests P1 and P2, P3 . . . ), with the representation of the evaluation-target agent (ant, cuckoo, or the like) in each optimization calculating method.

In that case, by the optimization calculating method, the evaluation value concerning the fitness with respect to the specific operation is acquired while initializing the layout of the robot arm A (the fixing base F thereof) and the peripheral devices (the work piece rests P1, P2, P3 . . . ) or performing the update using it as a start point. Then, the layout corresponding to the best evaluation value acquired is output and set. In this case, in the present embodiment, the operation speed of the robot arm or the required time is used as the evaluation value.

Incidentally, it should be noted that the examples described in the first embodiment are merely examples, and the scope of the claims of the present invention is not limited by them. It is needless to say that the technique described in the scope of the claims includes various modifications and changes of the above exemplified specific examples.

### Second Embodiment

In the second embodiment, the method for evaluating the layout is changed from that in the first embodiment. That is, in the first embodiment, when the initial layout is generated, only the layout in which the peripheral devices (the work piece rests P1 to P3) and the obstacle O do not interfere with the robot arm A, the inverse kinematics at the teaching point is solved, and the interference avoidance trajectory generation succeeds is left, and the layout which is left is evaluated.

On the other hand, in the second embodiment, when the initial layout is generated, merely initialization of the position of the particle is performed at random. Namely, it is not checked whether or not the interference occurs, whether or not the inverse kinematics can be solved at the teaching point, and whether or not the interference avoidance trajectory generation succeeds.

Besides, in the first embodiment, it is conditioned that the robot arm A does not interfere with the peripheral device in the initialization of the position of the particle and that the inverse kinematics can be solved at the teaching point. Therefore, conversely, when the layout is evaluated, only the operation time of the robot arm is evaluated. On the other hand, in the second embodiment, in the case where the interference occurs at the stage of the layout evaluation, in the case where the inverse kinematics at the teaching point cannot be solved, and in the case where the interference avoidance trajectory generation fails, then the evaluation value concerning the fitness in regard to the specific operation is given. In that case, when the interference occurs, when the inverse kinematics at the teaching point cannot be solved, and when the interference avoidance trajectory generation fails, it is controlled to give a low evaluation value.

In the second embodiment, an “evaluation index” is used to handle and manage the evaluation value. The evaluation index referred to in the second embodiment corresponds to a kind of evaluation, and further has a meaning of priority order with other evaluation indexes. In the second embodiment, pᵢ is the priority order of the evaluation index for the particle (i) alone, pᵢ̂ is the priority order of the evaluation index for which the highest evaluation of the particle alone is acquired so far, and p_{g}̂ is the priority order of the evaluation index in the highest evaluation in the previous process so far in all the particles.

In the second embodiment, the constitutions of the layout optimizing apparatus 100 and the operation processing unit 3 are assumed to be the same as those in the first embodiment, and a control procedure for performing layout optimization different from that in the first embodiment will be described.

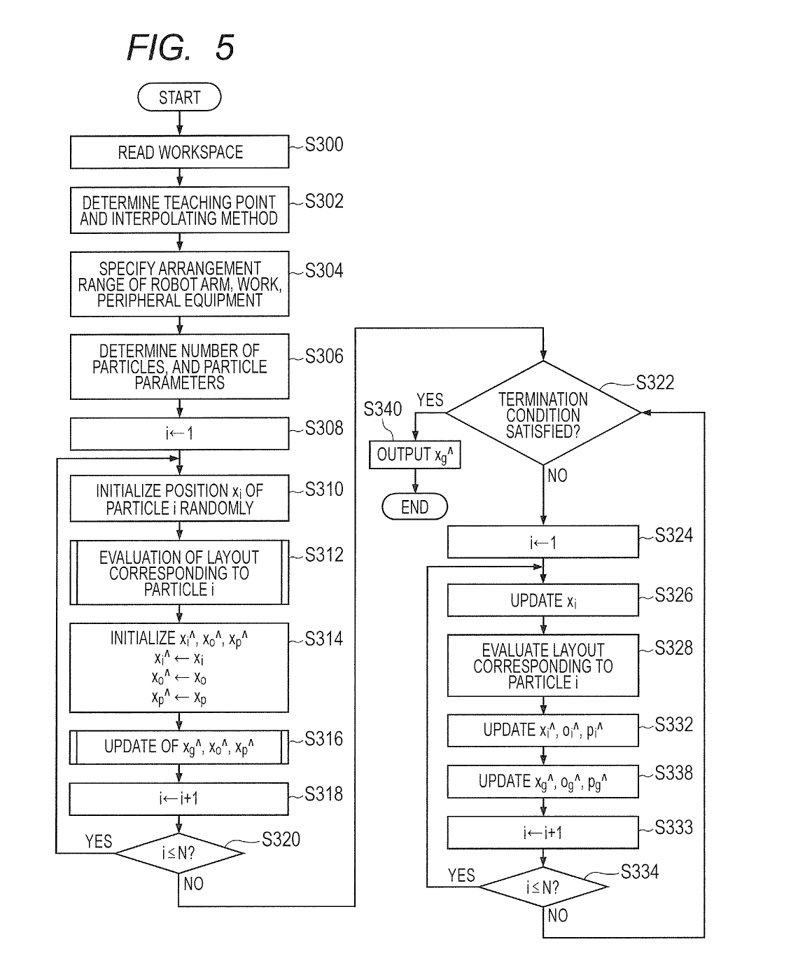

FIG. 5 illustrates a flow chart of the entire control procedure for performing the layout optimization according to the second embodiment.

Here, in the layout optimization of the second embodiment, it is assumed that the robot operation to be performed by the robot arm A (that is, the specific operation that the robot arm accesses the peripheral device) is as follows. That is, in the arrangement as illustrated in FIG. 1, the robot arm A grips the work piece W, and moves the gripped work piece W from the teaching point T1 fixed to the work piece rest P1 to the teaching point T2 fixed to the work piece rest P2 while avoiding the interference with the obstacle O. Subsequently, the robot arm A grips the work piece W, and moves it from the teaching point T2 fixed to the work piece rest P2 to the teaching point T3 fixed to the work piece rest P3 while avoiding the interference with the obstacle O.

In the layout optimization according to the second embodiment, the layout which is suitable for performing the above specific robot operation is acquired. Namely, the optimized positions and orientations of the fixing base F of the robot arm A and the work piece rests P1, P2 and P3 are acquired.

Initially, in S300 of FIG. 5, the three-dimensional shape of the workspace on the base B, the position and shape information of the robot arm A, the robot arm fixing base F, the obstacle O, the work piece W, and the work piece rests P1, P2 and P3 is acquired. For acquiring the shape information, the same method as that in the first embodiment (S100 of FIG. 3) may be used.

Next, in S302, the teaching point and the interpolating method corresponding to the specific operation to be performed by the robot arm A are set. As for the setting of the teaching point and the interpolating method, the same method as that in the first embodiment (S102 in FIG. 3) can be used. Here, it is assumed that the teaching points T1, T2 and T3 are specified to move by the joint interpolation.

In S304, the range of the positions and orientations of the fixing base F of the robot arm A, and the peripheral devices (peripheral equipment), that is, the work piece rests P1, P2 and P3 is specified. For example, when the range of the position and orientation of the fixing base F of the robot arm is specified, it is conceivable to specify the upper and lower limits of the coordinate parameter in the task space. Here, the position of the fixing base F of the robot arm is represented by, for example, x, y and z in the task space, and the rotation amounts α, β and γ around the respective axes as the ZYX Euler angles. Then, each of the coordinate values and the arrangement range of the Euler angles are set within the range between the minimum value and the maximum value as follows. In other words, the range from the lower limit (min) to the upper limit (max) of each of xₘᵢₙ<x<xₘₐₓ, yₘᵢₙ<y<yₘₐₓ, zₘᵢₙ<z<zₘₐₓ, αₘᵢₙ<α<αₘₐₓ, βₘᵢₙ<β<βₘₐₓ, and γₘᵢₙ<γ<γₘₐₓ. Likewise, the upper and lower limits of the coordinate parameters in the task (working) space on the base B are also specified for each of the work piece rests P1, P2 and P3.

In S306, the number N of the particles in the particle swarm optimization, and the parameters wᵢ, c₁ᵢ c₂ᵢ, r₁ᵢ and r₂ᵢ of the particle i are determined as much as the number of the particles. These parameters may be input by the operator from the operation unit 2, or a previously selected fixed value may be used for each of these parameters.

In S308, the loop variable i for controlling the number of performance times of the loop processes of S310 to S320 is initialized to 1. In the loop of S310 to S320, the loop variable i is changed from i=1 to N, and the layout corresponding to each of the N particles i is generated.

In S310, the position xᵢ of the particle is initialized by the initial layout generating unit 32. The relevant initializing process is similar to that in, for example, S200 of FIG. 4, and the position xᵢ of the particle i is randomly initialized (initial layout generating step). That is, the vector (xᵢ), which represents the layout, that is, the position and orientation of the robot arm A (robot arm fixing base F) and the positions and orientations of the work piece rests P1, P2 and P3, is generated using an appropriate random processing calculation. In S310, the particle swarm may be initialized by the random calculation as above, or a result optimized under another condition may be used for the initialization. In any case, the initialization is performed using the coordinate value within the arrangement range specified in S304.

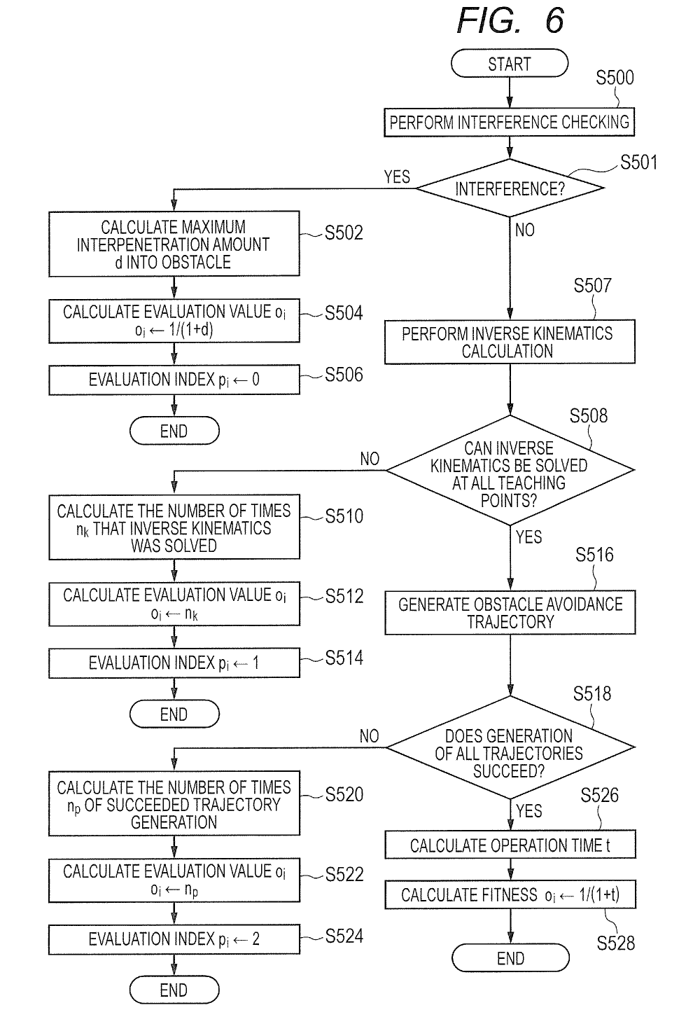

In S312, the generated layout corresponding to the particle i is evaluated. Such layout evaluation is performed according to a flow chart as illustrated in FIG. 6.

Initially, in S500 of FIG. 6, an interference checking calculation is performed to check whether or not, in the arrangement corresponding to the position xᵢ of the particle i, the robot arm A, the fixing base F of the robot arm A, the work piece W, the work piece rests P1, P2 and P3, the obstacle O and the like mutually interfere with others.

In S501, a result of such interference checking in S500 is determined. When there is interference between each of the above units (that is, between the robot arm and any of the peripheral devices and the obstacle O), the process advances to S502. On the other hand, when there is no interference, the process advances to S507.

In the case where the interference occurs, in S502, a maximum interpenetration (dent) amount d equivalent to the largest interpenetration into the interfered objects is calculated as its interference amount. The (maximum) interpenetration amount is represented by a physical amount corresponding to, for example, a polygon representing the object shape corresponding to each of the above units, a distance that the wire frame contours are interpenetrated into each other, or the like.

In S504, the evaluation value oᵢ is calculated according to the interpenetration amount calculated in S502. The evaluation value oᵢ is generated such that the evaluation value is lower as the interpenetration amount is larger, and that the evaluation value is higher as the interpenetration amount is smaller. For example, the evaluation value oᵢ is calculated as in the following expression (5). Here, 1 is added to the denominator to avoid zero percent.

oᵢ←1/(1+d) (5)

In S506, 0 is substituted for the evaluation index pᵢ of the particle i. As described above, the evaluation index corresponds to the kind of evaluation, and furthermore, it means the priority order with another evaluation index. The evaluation index pᵢ in case of the interference is 0 (lowest priority order).

In S507, the inverse kinematics calculation of the robot arm A is performed at all the teaching points T1, T2 and T3 relating to the position and orientation of the hand tip of the robot arm A.

In S508, it is determined whether or not all joint positions (angles) can be generated by the inverse kinematics calculation at all the teaching points T1, T2 and T3 in S507. Here, when even one of the inverse kinematics calculations at the teaching points has failed, the process advances to S510. On the other hand, when all the inverse kinematics calculations at the teaching points succeed, the process advances to S516. Incidentally, the reason why the inverse kinematics calculation becomes impossible is the same as that described in the first embodiment. For example, in a case where the teaching point is set such that the hand tip position of the robot arm comes to be above the work piece rest, when the work piece rest is too far from the robot arm, the hand tip of the robot arm does not reach the teaching point, so that the inverse kinematics calculation cannot be solved.

When it is determined in S508 that at least one inverse kinematics calculation has failed, the number of times nₖ that the inverse kinematics calculation was solved is counted in S510. For example, when the inverse kinematics calculation could be solved only for the orientation of T1 and the inverse kinematics calculation could not be solved for the orientations of T2 and T3 (that is, success at one teaching point and failure at other two teaching points), nₖ=1 is set. In the second embodiment, it is assumed that the evaluation value is higher as the value of nₖ is larger (higher).

In S512, the evaluation value is calculated from nₖ calculated in S512. More specifically, the evaluation value oᵢ is calculated as follows.

oᵢ←nₖ (6)

In S514, 1 is substituted for the evaluation index pᵢ.

In S516 of FIG. 6, an interference avoidance trajectory (trajectory generating step) is generated by the trajectory generating unit 34. Here, as well as the first embodiment, the interpolation is performed between the teaching points respectively indicating the start and end points such that the robot arm A avoids the interference with the peripheral devices (the work piece rests P1 to P3) and the obstacle O, by using the avoidance path generation technique such as the RRT or the like. After that, the interpolation is again performed to form the trajectory line including the movement speed information of the robot arm, and the trajectory is output.

As described above, in the second embodiment, the specific operation to be performed by the robot arm A is as follows. That is, in the environment of FIG. 1, the robot arm A grips and moves the work piece W from the teaching point T1 fixed to the work piece rest P1 to the teaching point T2 fixed to the work piece rest P2, while avoiding the interference with the obstacle O. Thereafter, the robot arm A grips and moves the work piece W from the teaching point T2 fixed to the work piece rest P2 to the teaching point T3 fixed to the work piece rest P3, while avoiding the interference with the obstacle O.

In S518, it is determined whether or not the generation of all the interference avoidance trajectories in S516 has succeeded. An example of failure to generate the avoidance trajectory here may be a case where the number of times of trials exceeds a threshold with the path search algorithm such as the RRT or the like.

In S520, the number of times nₚ of the successful (or succeeded) trajectory generations is calculated as a process to be performed when it is determined that the interference avoidance trajectory generation has failed in S518. Here, for example, it is assumed that the trajectory generation can be performed with respect to the operation (motion) of moving the arm from the teaching point T1 to the teaching point T2 fixed to the work piece rest P2 while avoiding the interference with the obstacle O. However, after then, if the trajectory cannot be generated with respect to the operation that the robot arm A grips and moves the work piece W from the teaching point T2 fixed to the work piece rest P2 to the teaching point T3 fixed to the work piece rest P3 while avoiding the interference with the obstacle O, the evaluation value nₚ is set to nₚ=1.

In S522, the evaluation value is determined from nₚ calculated in S520. That is, the evaluation value oᵢ is calculated as indicated by the following expression (7) so that the evaluation value becomes higher as the number of times that the trajectory generation can be performed is larger.

oᵢ←nₚ (7)

In S524, 2 is substituted for the evaluation index pᵢ. The priority order “2” of the evaluation index pᵢ is the highest priority order in the second embodiment. However, the setting of this priority order is merely an example, and it may be different from the above example depending on an application of the robot system and a specific operation to be performed. Also, it is conceivable to provide a user interface which allows to change assignment of the priority order of the evaluation index pᵢ by a menu dialog or the like of the operation unit 2. For example, the user interface like this is constituted to cause the operator to be able to arbitrarily set the priority order of the evaluation index pᵢ to be assigned to the above “the interference with the obstacle and the peripheral device”, “success and failure of the inverse kinematics calculation”, “success and failure of the generation of the (avoidance) trajectory”, and the like.

In S526, the operation time t of the robot arm A is calculated from the interference avoidance trajectory calculated in S516.

In S528, the evaluation value is calculated from the operation time t of the robot arm calculated in S526. For example, a reciprocal of the operation time t of the robot arm A is set as the evaluation value as indicated by the following expression (8) such that the evaluation value becomes high as the operation time is short. However, to prevent zero percent, a constant 1 is added to the denominator.

oᵢ←1/(1+t) (8)

Upon termination of the layout evaluation in S312 of FIG. 5, then xᵢ̂, oᵢ̂ and pᵢ̂ are initialized with xᵢ, oᵢ and pᵢ respectively in S314 of FIG. 5.

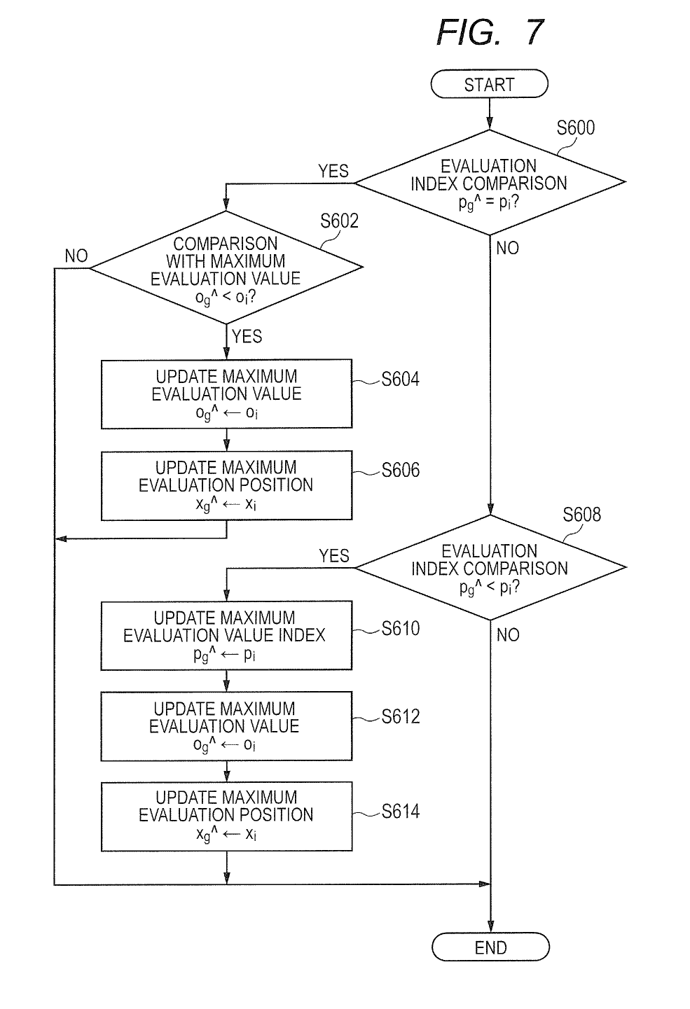

In S316, x_{g}̂, o_{g}̂ and p_{g}̂ are updated. A process procedure of such updating is illustrated in a flow chart of FIG. 7.

In S600 of FIG. 7, it is determined whether or not the maximum evaluation indexes p_{g}̂ and pᵢ in all the particles coincide with each other. Here, when p_{g}̂ and pᵢ coincide with each other, the process advances to S602. On the other hand, when they do not coincide with each other, the process advances to S608.

In S602, the size of the maximum evaluation value o_{g}̂ in the entire particle swarm is compared with the size of the evaluation value oᵢ of the particle alone. Then, when oᵢ is larger, the process advances to S604. On the other hand, when such a condition is not satisfied, the updating process is terminated.

Subsequently, oᵢ is substituted for o_{g}̂ in S604, and xᵢ is substituted for x_{g}̂ in S606.

In S608, p_{g}̂ and pᵢ are compared with each other. Then, when pᵢ is larger, the process advances to S610, otherwise, the updating process is terminated.

In S610, pᵢ is substituted for p_{g}̂, and, in S612, oᵢ is substituted for o_{g}̂. In S614, xᵢ is substituted for x_{g}̂.

Upon termination of the updating processes of x_{g}̂, xₒ̂ and xₚ̂ (S316 in FIG. 5, FIG. 7) as described above, the loop variable i is incremented by 1 in S318 of FIG. 5. Then, in S320, it is determined whether or not i is equal to or lower than N. When it is determined that i is equal to or lower than N (since the N initial layouts have not yet been processed yet), the process returns to S310.

In S322, it is determined whether or not an optimization termination condition is satisfied. The termination condition to be determined here is determined, for example, based on whether or not the evaluation value p_{g}̂ which has been the highest evaluation so far exceeds the previously input target value (evaluation value threshold). Then, when the termination condition like this is satisfied, x_{g}̂ is output in S340 and the layout optimization is terminated. For such an outputting process, the method similar to that described in the first embodiment can be used.

When the process reaches S322 for the first time, the termination condition is not established, and a layout evaluating process in S324 and the following steps is performed.

In the layout evaluating process, the loop variable i is first initialized to 1 in S324. In S326, the position xᵢ of the particle i is updated according to expressions (1) and (2), for example.

In S328, as well as S312, the evaluation value oᵢ and the evaluation index pᵢ of the particle i are calculated. Then, in S332, xᵢ̂, oᵢ̂ and pᵢ̂ are updated by the layout evaluating process (S316) illustrated in FIG. 7. However, in S332, it is assumed that process in which x_{g}̂, o_{g}̂ and p_{g}̂ in FIG. 7 are replaced with xᵢ̂, oᵢ̂ and pᵢ̂ respectively is performed.

In S333, the loop variable i is incremented by 1, and, in S334, it is determined whether or not i is equal to or lower than N. Then, when i is equal to or lower than N (since all the N layouts have not yet been processed), the process returns to S322 to repeat the above processes.

In S338, as well as S316, x_{g}̂, o_{g}̂ and p_{g}̂ are updated by the layout evaluating process (S316) illustrated in FIG. 7.

As described above, according to the present embodiment, it is possible to efficiently and at high speed calculate the layout and the operations of the robot arm A (the fixing base F thereof) and the peripheral devices (the work piece rests P1, P2, P3 . . . ), suitable for the specific operation (predetermined process) of the robot arm A.

In the second embodiment, the method of evaluating the layout is changed from that in the first embodiment. Namely, in case of evaluating the layout, the evaluation values are respectively given even when the interference occurs, even when the inverse kinematics calculation at the teaching point cannot be solved, and even when the interference avoidance trajectory generation fails. Besides, in the layout evaluation (S322 to S334 in FIG. 5), the optimization is performed by the particle swarm optimization while updating the particle i corresponding to the layout by applying these evaluation values, so that it is possible to set the satisfactory layout more efficiently.

Incidentally, as well as the first embodiment, also in the second embodiment, it is possible to change the particle swarm optimizing process used for the layout evaluation (optimization) to another meta-heuristic calculation, particularly, the swarm intelligence process. Also, in the second embodiment, it should be noted that the examples described above are merely examples, and the scope of the claims of the present invention is not limited by them. It is needless to say that the technique described in the scope of the claims includes various modifications and changes of the above exemplified specific examples.

### Third Embodiment

The third embodiment is different from the first and second embodiments in handling of the layout in which the interference occurs, handling of the layout in which the inverse kinematics calculation of the robot arm A cannot be performed, and handling of the layout in which the interference avoidance trajectory cannot be generated.

In the first and second embodiments, the optimization calculation is terminated at one time when the layout is evaluated. On the other hand, in the third embodiment, first, the optimization calculation of the layout is performed by using, as the evaluation value concerning the fitness with respect to the specific operation, the number of the teaching points for which the inverse kinematics calculation of the robot arm A can be performed without any interference. In the process of calculation, if even one layout in which the inverse kinematics calculation can be performed at all the teaching points without any interference can be generated, the particles in the particle swarm optimization are again initialized, and the optimization calculation is repeated. By repeating the optimization calculation, it is possible to generate the layouts of which the number is equivalent to the number of the particles, in which any interference does not occur, and in which the inverse kinematics calculation is established at all the teaching points. Thereafter, the layout optimization is performed based on the operation time and the evaluation as to whether or not the interference avoidance trajectory can be generated, so that the satisfactory layout is generated.

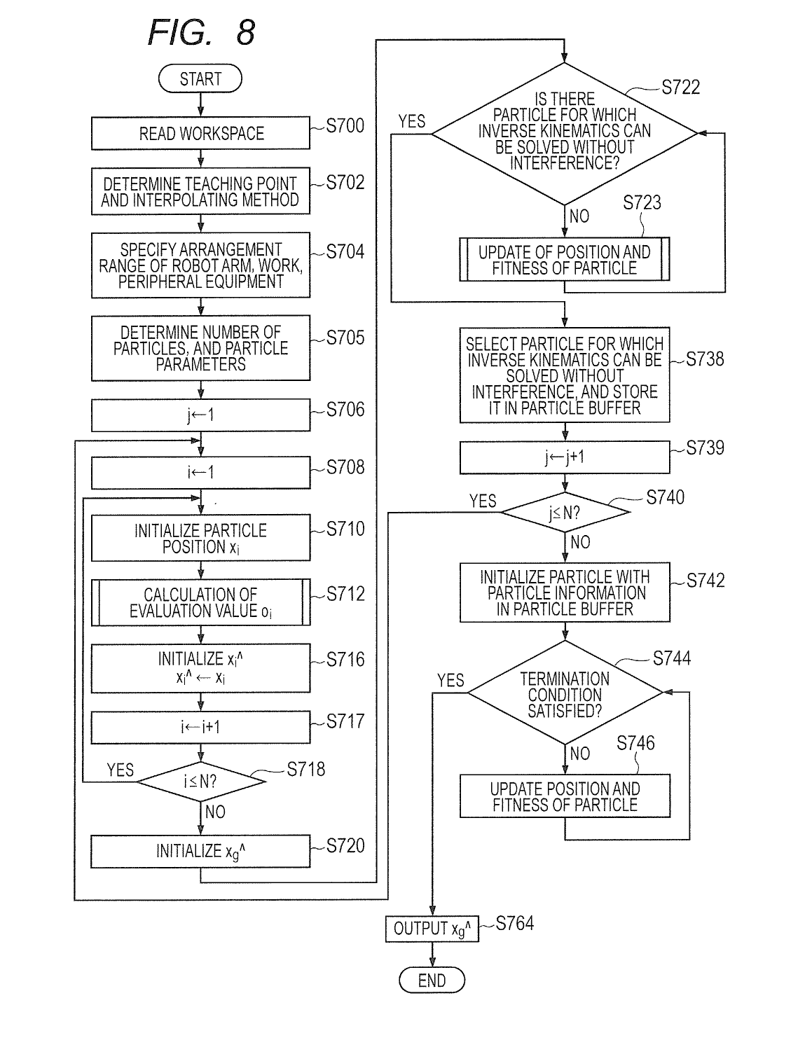

FIG. 8 is a flow chart which corresponds to the flow chart of FIG. 3 according to the first embodiment and the flow chart of FIG. 5 according to the second embodiment, and illustrates a control procedure of the layout optimization according to the third embodiment. Also in the layout optimizing method of the third embodiment, it is assumed that the robot operation to be performed by the robot arm A (the specific operation of accessing the peripheral device) is as follows. That is, in the environment of FIG. 1, the robot arm A grips and moves the work piece W from the teaching point T1 fixed to the work piece rest P1 to the teaching point T2 fixed to the work piece rest P2, while avoiding the interference with the obstacle O. Thereafter, the robot arm A grips and moves the work piece W from the teaching point T2 fixed to the work piece rest P2 to the teaching point T3 fixed to the work piece rest P3, while avoiding the interference with the obstacle O.

Then, in the layout optimization of the third embodiment, the layout which is suitable for performing such a specific robot operation, that is, the optimized positions and orientations of the fixing base F of the robot arm A, and the work piece rests P1, P2 and P3, is acquired.

First, in S700 of FIG. 8, the three-dimensional shape of the workspace on the base B, the position and shape information of the robot arm A, the robot arm fixing base F, the obstacle O, the work piece W and the work piece rests P1, P2 and P3 are acquired. For acquiring such shape information, the same method as that in the first embodiment (S100 in FIG. 3) or the second embodiment (S300 in FIG. 5) may be used.

Next, in S702, the teaching point corresponding to the specific operation to be performed by the robot arm A and the interpolating method are set. As for setting of the teaching point and the interpolating method, the same method as that in the first embodiment (S102 in FIG. 3) or the second embodiment (S302 in FIG. 5) can be used. Here, it is assumed that the teaching points T1, T2 and T3 are specified to move by the joint interpolation.

In S704, the range of the positions and orientations of the fixing base F of the robot arm A, and the peripheral devices (peripheral equipment), that is, the work piece rests P1, P2 and P3 is specified. For example, when the range of the position and orientation of the fixing base F of the robot arm is specified, it is conceivable to specify the upper limit and the lower limit of the coordinate parameter on the task space. Also in the present embodiment, here, the position of the fixing base F of the robot arm is represented by, for example, x, y and z in the task space, and the rotation amounts α, β and γ around the respective axes as the ZYX Euler angles. Then, the arrangement range of each of the coordinate values and the Euler angles is set within the range between the minimum value and the maximum value as follows, that is, the range from the lower limit (min) to the upper limit (max) of each of xₘᵢₙ<x<xₘₐₓ, yₘᵢₙ<y<yₘₐₓ, zₘᵢₙ<z<zₘₐₓ, αₘᵢₙ<α<αₘₐₓ, βₘᵢₙ<β<βₘₐₓ, and γₘᵢₙ<γ<γₘₐₓ. In S704, within this range, the range of the positions and orientations of the fixing base F of the robot arm A and the peripheral devices (peripheral equipment), that is, the work piece rests P1, P2 and P3, is specified. Likewise, the upper and lower limits of the coordinate parameters in the task (working) space on the base B are also specified for each of the work piece rests P1, P2 and P3.

In S705, the number N of particles in the particle swarm optimization is determined, and also the parameters wᵢ, c₁ᵢ, c₂ᵢ, r₁ᵢ and r₂ᵢ of the particle i are determined as much as the number of the particles. These parameters may be input by the operator from the operation unit 2, or the previously selected fixed values may be used as these parameters.

Subsequently, a loop variable j and the loop variable i are initialized to 1 respectively in S706 and S708. Here, the loop variable j is used to control the number of performance times of the loop processes of S708 to S740, and the loop variable i is used to control the number of performance times of the loop processes of S710 to S718.

In S710, the position xᵢ of the particle is initialized by the initial layout generating unit 32 (initial layout generating step). The relevant initializing process is similar to, for example, the process in S200 of FIG. 4, and the position xᵢ of the particle i is initialized. The vector (xᵢ), which represents the layout, that is, the position and orientation of the robot arm A (robot arm fixing base F) and the positions and orientations of the work piece rests P1, P2 and P3, is generated using an appropriate random processing calculation. In S710, the particle swarm may be initialized by the random calculation as above, or a result optimized under another condition may be used for the initialization. In any case, the initialization is performed using the coordinate value within the arrangement range specified in S704.

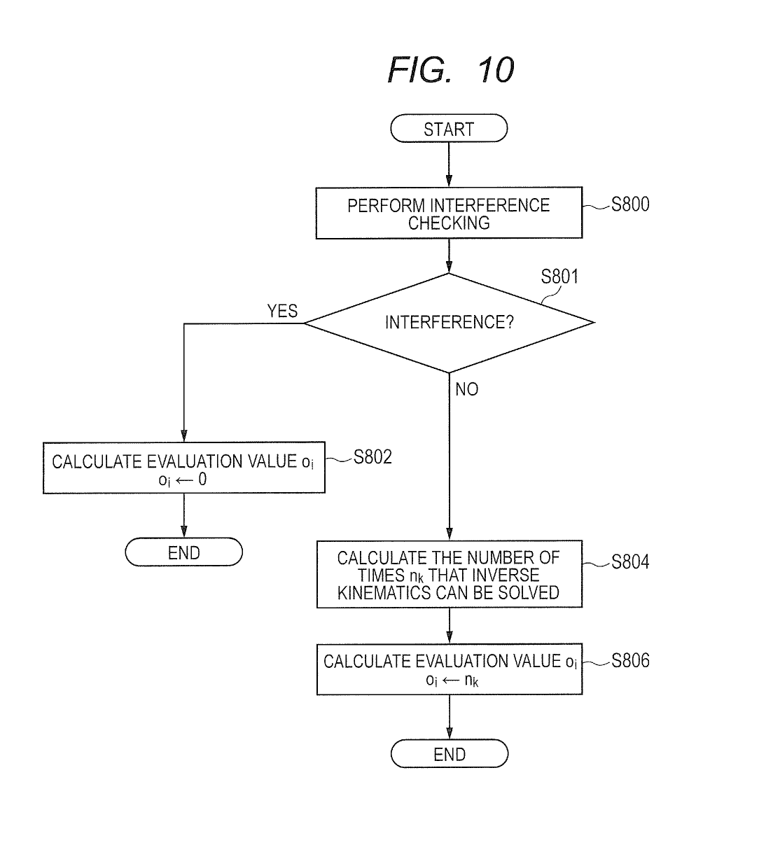

In S712, the generated layout corresponding to the particle i is evaluated. Such layout evaluation is performed according to a flow chart as illustrated in FIG. 10.

In S800 of FIG. 10, the interference checking calculation is performed to check whether or not, in the arrangement corresponding to the position xᵢ of the particle i, the robot arm A, the fixing base F of the robot arm A, the work piece W, the work piece rests P1, P2 and P3, and the obstacle O mutually interfere with others.

In S801, a result of such interference checking in S800 is determined. When there is interference between each of the above units (that is, between the robot arm and any of the peripheral devices and the obstacle O), the process advances to S802. On the other hand, when there is no interference, the process advances to S804.

When there is the interference, in S802, 0 is substituted for oᵢ as the evaluation value in the case of the interference, and the layout evaluation is terminated.

On the other hand, in S804, the inverse kinematics calculation of the robot arm A is performed at all the teaching points T1, T2 and T3 concerning the position and orientation of the hand tip of the robot arm A corresponding to the specific operation, and the number of times nₖ that the inverse kinematics calculation was solved is counted. For example, when the inverse kinematics calculation is solved only for the orientation of the teaching point T1 and the inverse kinematics calculation is not solved for the orientations of the teaching points T2 and T3, nₖ=1 is set (succeeded only once). The evaluation value nₖ concerning the inverse kinematics calculation is generated such that the evaluation becomes higher as the evaluation value nₖ becomes larger (higher).

In S806, the evaluation value oᵢ is calculated from the evaluation value nₖ calculated in S804 according to the following expression (9), and the layout evaluating process is terminated.

oᵢ←nₖ (9)

When the layout evaluation of FIG. 10 (S712 of FIG. 8) is terminated, xᵢ and oᵢ̂ are initialized with xᵢ and oᵢ respectively in S716 of FIG. 8.

In S717, the loop variable i is incremented by 1, and, in S718, it is determined whether or not i is equal to or lower than N. When i is equal to or lower than N (evaluation of N particles has not been terminated), the process returns to S710 to repeat the above processes.

In S720, x_{g}̂ and o_{g}̂ are initialized. As a procedure for the initialization, the particle having the highest evaluation value oᵢ is calculated, and xᵢ and oᵢ of the particle are substituted for x_{g}̂, o_{g}̂ and p_{g}̂.

In S722, it is determined whether or not, among the layouts corresponding to the particle swarm, there is the layout in which the inverse kinematics calculation can be performed at all the teaching points without any interference. For such determination, the value of the evaluation value o generated in S806 and S810 of FIG. 10 can be used. Here, when there is such an available layout, the process advances to S738. On the other hand, when there is no such layout, the process advances to S723.

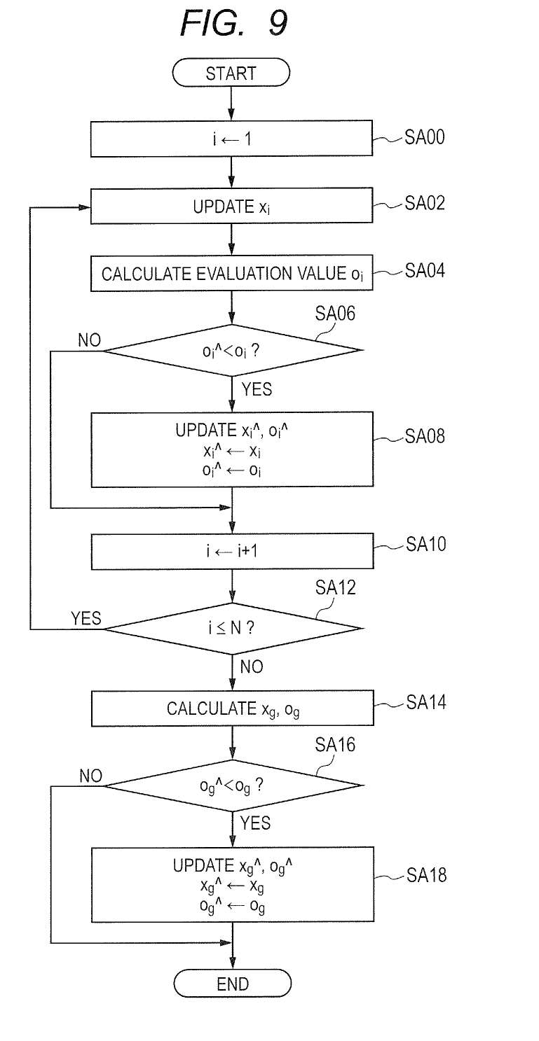

In S723, the position and the fitness of the particle i are updated. A flow of updating the position and the fitness of the particle i in S723 is illustrated in FIG. 9.

Initially, in SA00 of FIG. 9, the loop variable i is initialized to 1. It is assumed that the relevant loop variable i is a local variable which is allocated on a stack or the like and can be operated and handled independently from i of FIG. 8.

In SA02, xᵢ is updated according to the expressions (1) and (2). In SA04, as well as S712, the evaluation value oᵢ of the particle i is calculated.

Subsequently, in SA06, the evaluation value oᵢ̂ is compared with the evaluation value oᵢ. Then, when oᵢ is higher, the process advances to SA08, otherwise, the process advances to SA12.

In SA08, the position xᵢ is substitute for the position xᵢ̂ of the best particle, and oᵢ is substituted for the evaluation value oᵢ̂.

In SA10, the loop variable i is incremented by 1, and, in SA12, it is determined whether or not i is equal to or lower than N (whether all the N particles have been processed). Then, when i is equal to or lower than N, the process returns to SA02 to repeat the above processes.

In SA14, the calculation of x_{g} and o_{g} is first performed. In this case, the maximum value in the i evaluation values oᵢ is substituted for o_{g} as indicated by the following expression (10).

$${o}_{g} ← {max}_{i} {o}_{i} \qquad ( 10 )$$

Besides, x_{g} is updated at the position xᵢ of the particle i where oᵢ becomes maximum.

In SA16, o_{g}̂ is compared with o_{g}. Then, when o_{g} exceeds o_{g}̂, x_{g}̂ is updated with x_{g} and o_{g}̂ is updated with o_{g} in SA18, and the position and fitness updating of FIG. 9 (S723 of FIG. 8) is terminated.

Subsequently, in S738 of FIG. 8, the particle that the inverse kinematics calculation is solved at all the teaching points without any interference is selected as a preservation particle j and stored in a particle buffer.

In S739, the loop variable j is incremented by 1, and, in S740, it is determined whether or not j is equal to or lower than N. When j is equal to or lower than N, the process returns to S708 to repeat the above processes. On the other hand, when j reaches N, the process advances to S742.

In S742, the position xᵢ and the evaluation value oᵢ of the particle i (i=1 to N) are initialized with the preservation particle j (j=1 to N) in the particle buffer.

In S744, it is determined whether or not the termination condition of the optimization is satisfied. For example, the termination condition is determined based on whether or not the evaluation value o_{g}̂ which was the highest overall up to now exceeds a previously input target value (a threshold of the evaluation value). When the termination condition is satisfied, the layout corresponding to the optimized particle position x_{g}̂ is output in S764, and the layout optimization is terminated. For such an outputting process of S764, the method same as that described in the first embodiment can be used.

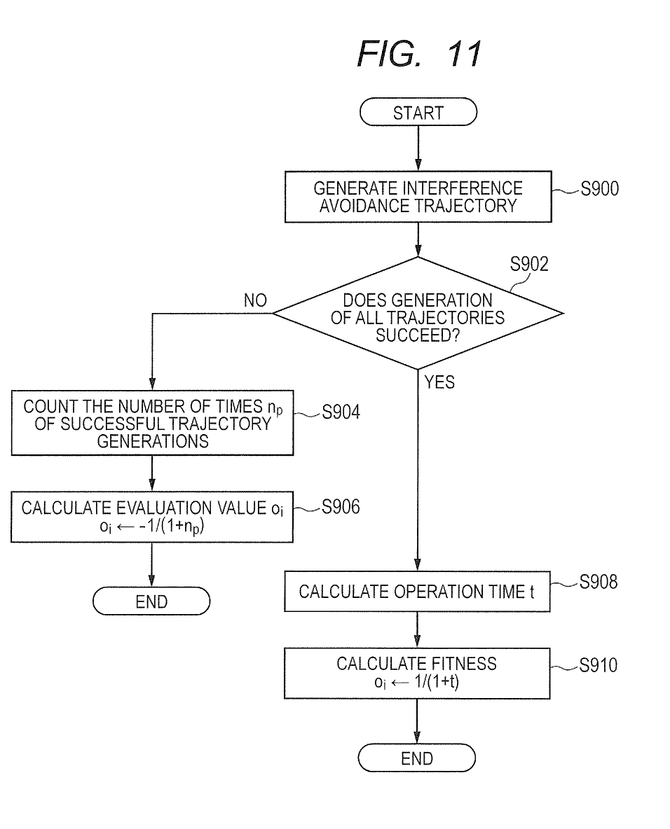

On the other hand, when the termination condition of the optimization is not satisfied, in S746, the layout is evaluated in a processing procedure as illustrated in FIG. 11.

In S900, the interference avoidance trajectory is generated by the trajectory generating unit 34. Here, as well as the first embodiment, the interpolation is performed between the teaching points respectively indicating the start and end points such that the robot arm A avoids the interference with the peripheral devices (the work piece rests P1 to P3) and the obstacle O, by using the avoidance path generation technique such as the RRT or the like. After that, the interpolation is again performed to form the trajectory line including the movement speed information of the robot arm, and the trajectory is output.

As described above, in the third embodiment, the specific operation to be performed by the robot arm A for accessing the peripheral device is as follows. That is, in the environment of FIG. 1, the robot arm A grips and moves the work piece W from the teaching point T1 fixed to the work piece rest P1 to the teaching point T2 fixed to the work piece rest P2, while avoiding the interference with the obstacle O. Thereafter, the robot arm A grips and moves the work piece W from the teaching point T2 fixed to the work piece rest P2 to the teaching point T3 fixed to the work piece rest P3, while avoiding the interference with the obstacle O.

In S902, it is determined whether or not the generation of all the interference avoidance trajectories in S900 has succeeded. An example of failure to generate the avoidance trajectory here may be a case where the number of times of trials exceeds a threshold with the path search algorithm such as the RRT or the like.

In S904, the number of times nₚ of the successful (or succeeded) trajectory generations is calculated when it is determined that the interference avoidance trajectory generation has failed in S902. Here, for example, it is assumed that the trajectory generation can be performed with respect to the operation of moving the arm from the teaching point T1 to the teaching point T2 fixed to the work piece rest P2 while avoiding the interference with the obstacle O. However, after then, if the trajectory cannot be generated with respect to the operation that the robot arm A grips and moves the work piece W from the teaching point T2 fixed to the work piece rest P2 to the teaching point T3 fixed to the work piece rest P3 while avoiding the interference with the obstacle O, nₚ=1 is set.

In S906, the evaluation value is determined from n calculated in S904. It is determined that the evaluation value is higher if the number of times that the trajectory generation could be performed is larger, and the evaluation value oᵢ is calculated according to the following expression (11). However, here, a constant 1 is added to the denominator to prevent zero percent.

oᵢ←−1/(1+nₚ) (11)

Incidentally, the reason why the evaluation value oᵢ is made minus here is as follows. That is, if the evaluation based on the operation time is performed in plus and the evaluation based on the number of times that the trajectory generation succeeds is in minus, the evaluations in different dimensions can be continuously performed using the evaluation values being one scalar. After the evaluation value oᵢ is generated in S906, the layout evaluating process described with reference FIG. 11 is terminated.

On the other hand, when all the interference avoidance trajectories have been generated in S902, in S908, the operation time t of the robot arm is calculated from the interference avoidance trajectory calculated in S902. Subsequently, in S910, the evaluation value oᵢ is generated from the operation time t of the robot arm calculated in S908. Here, a reciprocal of the operation time of the robot arm is generated as the evaluation value by a process of, for example, the following expression (12), such that the evaluation value becomes high as the operation time is short. However, also in this case, a constant 1 is added to the denominator to prevent zero percent.

oᵢ←1/(1+t) (12)

Upon termination of S910, the layout evaluating process described with reference FIG. 11 (S746 of FIG. 8) is terminated, and the process returns to S744. Thus, it is determined whether or not the termination condition is satisfied for the particle swarm in which the position and the evaluation value (fitness) oᵢ of each particle has been updated again.

As described above, according to the present embodiment, it is possible to efficiently and at high speed calculate the layout and the operations of the robot arm A (the fixing base F thereof) and the peripheral devices (the work piece rests P1, P2, P3 . . . ), suitable for the specific operation (predetermined process) that the robot arm A accesses the peripheral device.

Incidentally, the third embodiment is different from the first and second embodiments in the handling of the layout in which the interference occurs, the handling of the layout in which the inverse kinematics calculation of the robot arm A cannot be performed, and the handling of the layout in which the interference avoidance trajectory cannot be generated. First, the optimization calculation of the layout is performed using the number of the teaching points for which the inverse kinematics calculation of the robot arm A can be calculated without any interference as the evaluation value. Then, only for the layout in which the inverse kinematics calculation can be performed, the evaluation as to whether or not the operation time and the interference avoidance trajectory can be generated is performed, the layout optimization is performed, so that the satisfactory layout is generated. Namely, the optimization calculation is divided into two and then performed. By the optimizing process like this, it is possible to separate the optimization calculation about the plurality of evaluation indexes, and it is thus possible to efficiently perform the optimization calculation.

Incidentally, as well as the first and second embodiments, also in the third embodiment, it is possible to change the particle swarm optimizing process used for the layout evaluation (optimization) to another meta-heuristic calculation, particularly, the swarm intelligence process. Also, in the third embodiment, it should be noted that the examples described above are merely examples, and the scope of the claims of the present invention is not limited by them. It is needless to say that the technique described in the scope of the claims includes various modifications and changes of the above exemplified specific examples.

### DESCRIPTION OF REFERENCE SYMBOLS/NUMERALS

A . . . robot arm; B . . . base; O . . . obstacle; P . . . work piece rest; W . . . work piece; 2 . . . operation unit; 3 . . . calculation processing unit; 40 . . . storing unit; and 100 . . . layout optimizing apparatus.

### EFFECT OF THE INVENTION

According to the above-described constitutions, it is possible to efficiently and at high speed calculate the optimum layout of the robot arm and the peripheral device and the optimum operation (motion) thereof, in order to cause the robot arm to perform the specific operation.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-153890, filed Aug. 4, 2016, which is hereby incorporated by reference herein in its entirety.

What is claimed is:

1. A layout setting method for a robot arm and a peripheral device in a robot workspace, the method comprising:
a teaching point acquiring step of causing a controlling device to acquire a teaching point which corresponds to a specific operation that the robot arm accesses the peripheral device, and through which the controlling device allows a reference region of the robot arm to pass;
an initial layout generating step of causing the controlling device to generate an initial layout of the robot arm and the peripheral device;
a trajectory generating step of causing the controlling device to generate a trajectory of the robot arm based on the teaching point;
a layout changing step of causing the controlling device to generate a new layout by changing an arrangement of the robot arm or the peripheral device based on the initial layout; and
a layout setting step of causing the controlling device to set an evaluation value concerning fitness for the specific operation in the initial layout or the new layout, and set the initial layout or the new layout based on the set evaluation value.

2. The layout setting method according to claim 1, wherein, in the layout changing step, the controlling device generates the new layout until the evaluation value concerning the fitness for the specific operation exceeds a previously input target value.

3. The layout setting method according to claim 1, wherein, in the layout changing step and the layout setting step, the controlling device generates the new layout and sets the initial layout or the new layout respectively by using a meta-heuristic calculation.

4. The layout setting method according to claim 3, wherein the meta-heuristic calculation includes a particle swarm optimization calculation.

5. The layout setting method according to claim 4, wherein, in the particle swarm optimization calculation, the controlling device generates the new layout by associating the robot arm and the peripheral device with a particle in the particle swarm optimization calculation and changing positions and speeds corresponding to positions and orientations of the robot arm and the peripheral device of the particle.

6. The layout setting method according to claim 1, wherein, in the layout setting step, the controlling device uses, as the set evaluation value, an operation time that the robot arm operates on the trajectory generated in the trajectory generating step.

7. The layout setting method according to claim 1, wherein, in the trajectory generating step, the controlling device generates the trajectory which can avoid the robot arm from interfering with another peripheral device different from the peripheral device to be accessed in an operation related to the trajectory generation or an obstacle included in the robot workspace.

8. The layout setting method according to claim 7, wherein, in the layout setting step, the controlling device uses, as the set evaluation value, an interference amount between the robot arm and the another peripheral device or the obstacle.

9. The layout setting method according to claim 7, wherein, in the layout setting step, the controlling device uses, as the set evaluation value, the number of times that the trajectory capable of avoiding the interference between the robot arm and the another peripheral device or the obstacle was generated in the trajectory generating step.

10. The layout setting method according to claim 7, wherein, in the layout setting step, the controlling device uses, as the set evaluation value, the number of the teaching points which were acquired in the teaching point acquiring step and each for which an inverse kinematics calculation of the robot arm has been established.

11. A control program for causing a controlling device to perform each step of a layout setting method for a robot arm and a peripheral device in a robot workspace, the method comprising:
a teaching point acquiring step of causing the controlling device to acquire a teaching point which corresponds to a specific operation that the robot arm accesses the peripheral device, and through which the controlling device allows a reference region of the robot arm to pass;
an initial layout generating step of causing the controlling device to generate an initial layout of the robot arm and the peripheral device;
a trajectory generating step of causing the controlling device to generate a trajectory of the robot arm based on the teaching point;
a layout changing step of causing the controlling device to generate a new layout by changing an arrangement of the robot arm or the peripheral device based on the initial layout; and
a layout setting step of causing the controlling device to set an evaluation value concerning fitness for the specific operation in the initial layout or the new layout, and set the initial layout or the new layout based on the set evaluation value.

12. A non-transitory computer-readable storage medium of storing a control program for causing a controlling device to perform each step of a layout setting method for a robot arm and a peripheral device in a robot workspace, the method comprising:
a teaching point acquiring step of causing the controlling device to acquire a teaching point which corresponds to a specific operation that the robot arm accesses the peripheral device, and through which the controlling device allows a reference region of the robot arm to pass;
an initial layout generating step of causing the controlling device to generate an initial layout of the robot arm and the peripheral device;
a trajectory generating step of causing the controlling device to generate a trajectory of the robot arm based on the teaching point;
a layout changing step of causing the controlling device to generate a new layout by changing an arrangement of the robot arm or the peripheral device based on the initial layout; and
a layout setting step of causing the controlling device to set an evaluation value concerning fitness for the specific operation in the initial layout or the new layout, and set the initial layout or the new layout based on the set evaluation value.

13. A layout setting apparatus comprising a 3D (three-dimensional) outputting device, wherein
on the basis of 3D data of a robot arm, a peripheral device and a robot workspace in a layout setting method for the robot arm and the peripheral device in the robot workspace, the method comprising a teaching point acquiring step of causing a controlling device to acquire a teaching point which corresponds to a specific operation that the robot arm accesses the peripheral device, and through which the controlling device allows a reference region of the robot arm to pass; an initial layout generating step of causing the controlling device to generate an initial layout of the robot arm and the peripheral device; a trajectory generating step of causing the controlling device to generate a trajectory of the robot arm based on the teaching point; a layout changing step of causing the controlling device to generate a new layout by changing an arrangement of the robot arm or the peripheral device based on the initial layout; and a layout setting step of causing the controlling device to set an evaluation value concerning fitness for the specific operation in the initial layout or the new layout, and set the initial layout or the new layout based on the set evaluation value: the 3D outputting device is configured to three-dimensionally output an arrangement configuration of the robot arm and the peripheral device in the robot workspace in the initial layout or the new layout.

14. The layout setting apparatus according to claim 13, further comprising a user interface configured to cause an operator to create the initial layout or correct the initial layout or the new layout, while causing the operator to confirm, with the 3D outputting device, a state of the arrangement configuration of the robot arm and the peripheral device in the robot workspace.

15. The layout setting apparatus according to claim 13, wherein, while performing the layout changing step or the trajectory generating step, the controlling device is configured to cause the 3D outputting device to three-dimensionally output in real time a state of the arrangement configuration of the robot arm and the peripheral device or the position and orientation of the robot arm in the robot workspace.

16. A part manufacturing method of manufacturing a part by a robot arm arranged using a layout setting method for the robot arm and a peripheral device in a robot workspace, the method comprising:
a teaching point acquiring step of causing a controlling device to acquire a teaching point which corresponds to a specific operation that the robot arm accesses the peripheral device, and through which the controlling device allows a reference region of the robot arm to pass;
an initial layout generating step of causing the controlling device to generate an initial layout of the robot arm and the peripheral device;
a trajectory generating step of causing the controlling device to generate a trajectory of the robot arm based on the teaching point;
a layout changing step of causing the controlling device to generate a new layout by changing an arrangement of the robot arm or the peripheral device based on the initial layout; and
a layout setting step of causing the controlling device to set an evaluation value concerning fitness for the specific operation in the initial layout or the new layout, and set the initial layout or the new layout based on the set evaluation value.

17. A robot system comprising a robot arm arranged using a layout setting method for the robot arm and a peripheral device in a robot workspace, the method comprising:
a teaching point acquiring step of causing a controlling device to acquire a teaching point which corresponds to a specific operation that the robot arm accesses the peripheral device, and through which the controlling device allows a reference region of the robot arm to pass;
an initial layout generating step of causing the controlling device to generate an initial layout of the robot arm and the peripheral device;
a trajectory generating step of causing the controlling device to generate a trajectory of the robot arm based on the teaching point;
a layout changing step of causing the controlling device to generate a new layout by changing an arrangement of the robot arm or the peripheral device based on the initial layout; and
a layout setting step of causing the controlling device to set an evaluation value concerning fitness for the specific operation in the initial layout or the new layout, and set the initial layout or the new layout based on the set evaluation value.

18. A robot controlling apparatus which performs a layout setting method for a robot arm and a peripheral device in a robot workspace, the method comprising:
a teaching point acquiring step of causing a controlling device to acquire a teaching point which corresponds to a specific operation that the robot arm accesses the peripheral device, and through which the controlling device allows a reference region of the robot arm to pass;
an initial layout generating step of causing the controlling device to generate an initial layout of the robot arm and the peripheral device;
a trajectory generating step of causing the controlling device to generate a trajectory of the robot arm based on the teaching point;
a layout changing step of causing the controlling device to generate a new layout by changing an arrangement of the robot arm or the peripheral device based on the initial layout; and
a layout setting step of causing the controlling device to set an evaluation value concerning fitness for the specific operation in the initial layout or the new layout, and set the initial layout or the new layout based on the set evaluation value.
